(19) United States
(12) Patent Application Publication
(10) Pub. No.: US 2024/0016144 A1
(43) Pub. Date: Jan. 18, 2024

(54) CLEAR, STABLE, WATER-BASED MICROEMULSION FORMULATIONS, COMPOSITIONS AND METHODS FOR PEST CONTROL

(71) Applicant: TYRATECH, INC., Morrisville, NC (US)

(72) Inventors: Jason Schmidt, Cary, NC (US); James Klimavicz, Cary, NC (US)

(21) Appl. No.: 18/255,112

(22) PCT Filed: Nov. 22, 2021
(86) PCT No.: PCT/US2021/060344

§ 371 Date: May 31, 2023

Related U.S. Application Data
(60) Provisional application No. 63/120,387, filed on Dec. 2, 2020.

(51) Int. Cl. A01N 25/04; A01N 25/30

(52) U.S. Cl. CPC A01N 25/04; A01N 25/30

(57) ABSTRACT

Clear, stable, water-based microemulsion formulations, compositions and methods are disclosed, comprising one or more anionic surfactants, one or more acylglycerol-derived emulsifiers, one or more water-soluble organic cosolvent, and optionally fatty acids and/or salts thereof.

### FIELD OF THE INVENTION

The present invention relates to methods of pest control employing clear, stable, water-based microemulsion formulations, compositions and methods comprising one or more anionic surfactants, one or more acylglycerol derived emulsifiers, a water-soluble organic cosolvent, and optionally fatty acids and/or salts thereof.

### BACKGROUND

While the first recorded use of chemicals to control pests dates back to 2500 BC, only in the last 60 years has chemical control has been widely used. Early pesticides included hellebore to control body lice, nicotine to control aphids, and pyrethrin to control a wide variety of insects. Lead arsenate was first used in 1892 as an orchard spray, while at the same time it was discovered that a mixture of lime and copper sulphate (Bordeaux mixture) controlled downy mildew, a fungal disease of grapes. Many of the more recent pesticides have been developed to target specific biochemical reactions within the target organism, e.g. an enzyme necessary for photosynthesis within a plant or a hormone required for normal development in an insect.

Recently, there has been increased research into the deleterious effects of chemical pesticides, with concomitant efforts to develop safer alternatives to current commercial pesticides. Some of this research has focused on the use of natural products, such as combinations of chemicals obtained from plants, such as essential oils.

In general, synthetic chemical pesticides and natural pesticides are applied in particular formulations that facilitate their use against pests in the field. For example, hydrophobic pesticidal compounds, such as many agrochemicals and plant essential oils are poorly soluble in water, but have been used in formulations, such as emulsions, that permitted admixture with water to form a spray. However, in general, these formulations have simply been employed to facilitate application of the pesticide directly to the pests or to the surfaces or environments inhabited by the pests.

Microemulsions are uniform and thermodynamically stable liquid mixtures of oil, water and one or more surfactant, in which the dispersed phase size range is roughly on the order of 5 to 100 nm in diameter. A microemulsion forms spontaneously upon mixing the components of the formulation; this is in contrast to the high-shear conditions required for the formation of a typical emulsion. The surfactant system is necessary to produce an ultra-low interfacial tension between the water and oil phases, thereby lowering the energy required to produce the high surface area required for a microemulsion. Because the surfactant component is a wetting agent that lowers the surface tension of liquid, microemulsions tend to consist of a mixture that can be spread easier than other mixtures and thus provide greater surface area. Perhaps for this reason, considerable attertion has been directed toward microemulsion-based pesticidal formulations, and microemulsion formulations appear to be an emerging standard for the formulation of hydrophobic pesticides in water-based carriers.

In addition, suspension concentrates, dispersions of sparingly soluble active ingredients in water or in organic solvents, are also employed in conjunction with pesticidal compositions. Suspension concentrate pesticidal compositions are concentrated suspensions of water-insoluble pesticides, frequently containing 10% to 80% by weight of pesticides, and can provide a method of handling relatively water-insoluble pesticides in an aqueous medium. In general, it can be desirable to formulate pesticides in suspension concentrates due to the advantage of not requiring the use of organic solvents, often present in emulsifiable concentrates. These formulations also include suspensions of microencapsulated or nanoencapsulated pesticides for use as emulsifiable or suspendable pesticide concentrates.

Furthermore, pesticides can also take the form of suspo-emulsions, also known as suspension emulsions, which are mixtures of suspensions and emulsions. These formulations are popular for combining several types of compounds into a single formulation, with stabilization through the choice of inert components and process control parameters.

Efforts to improve pesticides have been mainly directed toward discovering new compounds that may act as active ingredients of the pesticide. To date, however, attertion has not been focused on the optimization of formulations specifically as a route to improve the aesthetics, stability, and activity of pesticidal formulations.

### DESCRIPTION OF THE INVENTION

Unless otherwise noted, terms are to be understood according to conventional usage by those of ordinary skill in the relevant art.

As used herein, “oil” shall refer to any homogenous substance that is not miscible with water and exists as a liquid below 35° C. Oils may refer to pure compounds or mixtures of two or more compounds, including solutions of solid, liquid, or gaseous compounds in an oil to make a homogenous, non-water-miscible solution.

The present disclosure relates to emulsion-based formulations of pesticides, specifically pesticidal blends of essential oils and other ingredients, that have been found to enhance the aesthetics, stability, and activity of the pesticidal formulations. Surprisingly, the addition of the surfactant, emulsifier, and cosolvent to water in the correct proportions allows for the production of colorless, transparent oil-in-water microemulsions (“OWM”) capable of emulsifying water-immiscible oils and solids with poor aqueous solubility to a significant extert without becoming turbid while additionally retaining low viscosity.

Of additional interest are concentrates containing little or no water that may be diluted through the addition of water to form a clear, colorless OWM. As used herein, “concentrate” shall refer to any formulation that is intended to be mixed with water in a ratio of 2:1 to 100:1 of formulation to water to provide an emulsion or suspension of a pesticide for application.

As used herein, “pests” can mean any organism whose existence it can be desirable to control. Pests can include, for example, bacteria, cestodes, fungi, insects, nematodes, parasites, plants, and the like. “Pesticidal” can mean, for example, antibacterial, antifungal, antiparasitic, herbicidal, insecticidal, and the like.

As used herein, the term “pest control” shall refer to having a repellant effect, a pesticidal effect, or both. “Repellant effect” is an effect wherein more pests are repelled away from a host or area that has been treated with the composition than a control host or area that has not been treated with the composition. “Pesticidal effect” is an effect wherein treatment with a composition causes at least about 1% of the pests to die. In this regard, an LC₁ to LC₁₀₀ (lethal concentration) or an LD₁ to LD₁₀₀ (lethal dose) of a composition will cause a pesticidal effect. In some embodiments, the pesticidal effect is an effect wherein treatment with a composition causes at least about 5% of the exposed pests to die. In some embodiments, the pesticidal effect is an effect wherein treatment with a composition causes at least about 10% of the exposed pests to die. In some embodiments, the pesticidal effect is an effect wherein treatment with a composition causes at least about 25% of the pests to die. In some embodiments the pesticidal effect is an effect wherein treatment with a composition causes at least about 50% of the exposed pests to die. In some embodiments the pesticidal effect is an effect wherein treatment with a composition causes at least about 75% of the exposed pests to die. In some embodiments the pesticidal effect is an effect wherein treatment with a composition causes at least about 90% of the exposed pests to die.

The production of clear, colorless or nearly colorless microemulsions containing herbicidal, insecticidal, fungicidal, nematocidal, bactericidal, algicidal, or other pesticidal or pest repellent compounds or mixtures is of significant commercial interest. For example, such water-based, transparent formulations are appealing because they connote safety, purity, and spontaneity of use that are not typically associated with traditional synthetic pesticide chemistries. Additionally, the United States Environmental Protection Agency (“EPA”) and state regulatory agencies require that many pesticides have low volatile organic compound (“VOC”) contert; the current microemulsion formulations may be composed of compounds with no significant VOC contribution or are VOC-exempt, providing an additional commercial advantage. Furthermore, the microemulsion compositions can be produced containing only ingredients exempt from EPA registration by virtue of their appearance on the United States Federal Insecticide, Fungicide, and Rodenticide Act (FIFRA) 25(b) list or Class 4(a) inert ingredient list making the composition safe for use, and potertially eligible for classification as an organic pest control agent.

As used herein and known to one of skill in the art, the spectrum of various types of emulsions in terms of both water out and oil out, as well as size distribution of the emulsion are incorporated in the term “emulsions,” including microemulsions. Nevertheless, in particular embodiments of the present invention the formulation agents are not such as to form a microemulsion. Embodiments encompassing all or some formulations other than microemulsions are specifically contemplated.

As used herein, the term “RTU” means Ready-To-Use.

As used herein, “component of a composition” refers to a compound, or a subset of compounds included in a composition, e.g., the complete composition minus at least one compound.

As used herein, the term “about” or “approximately” means within an acceptable error range for the particular value as determined by one of ordinary skill in the art, which will depend in part on how the value is measured or determined, i.e., the limitations of the measurement system, i.e., the degree of precision required for a particular purpose, such as a pharmaceutical formulation. For example, “about” can mean within 1 or more than 1 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

As used herein, the term “substantially,” means at least about 70%, preferably at least about 80%, more preferably at least about 90%, and even more preferably at least about 99%, for example at least about 99.9%. In some embodiments, the term “substantially” can mean completely, or about 100%.

As used herein, a “plant essential oil” refers to all plant extractives and their physically modified derivatives such as tinctures, concretes, absolutes, essential oils, oleoresins, terpenes, terpene-free fractions, distillates, steam distillates, residues, enfleurage pomades, etc. that contain one or more volatile components, and may be derived from flowers, buds, leaves, bark, sapwood, heartwood, roots, roots, resin, peels, or other plant component, or combination of more than one of these components.

Plant essential oils may include, for example, agar oil, ajwain oil, almond extract, angelica root oil, anise oil, asafetida oil (from Ferula sp.), balsam of Peru (Myroxylon spp.), basil oil (Ocimum spp.), bay leaf oil (Laurus nobilis), bergamot oil, black pepper oil, birch oil (Betula spp.), Cannabis spp. oil, carrot oil, carrot seed oil, oils and extracts from Cinnamomum spp. (including camphor oil, cinnamon oil, cinnamon extract, cassia oil, Saigon cinnamon oil, Indian bay leaf oil, and Ceylon cinnamon oil), Citrus spp. oils (including neroli, petitgrain, calamondin oil, bergamot oil, mandarin oil, tangerine oil, citron oil, lime oil, orange oil, orange extract, grapefruit oil, and lemon oil, lemon extract), caraway seed oil, cedar oil (or cedarwood oil, from conifer families Cupressaceae and/or Pinaceae, including Virginia cedarwood oil, Texas cedarwood oil, Atlas cedar oil, and Himalayan cedar oil,), chamomile oil, calamus oil, cleary sage oil, coconut oil, clove oil, clove extract, coffee oil, coriander oil, costmary oil (Tanacetum balsamita), Costus spp. oil, cubeb oil, cumin seed oil, black cumin oil (Nigella sativa, black seed oil), cypress oil (Fokienia spp., fokenia oil), Cyperus scariosus oil (cypriol oil), curry leaf oil, davana oil, elemi oil, eucalyptus oil (from Eucalyptus spp.), fennel seed oil, fenugreek oil, frankincense oil, galangal oil, galbanum oil, garlic oil, geranium oil (Pelargonium spp., especially P. graveolens), ginger oil, ginger extract, guaiacwood oil, hyssop oil, jasmine oil, juniper berry oil (Juniperus sp.), lavender oil (Lavandula spp.), Ledum spp. oil, lemongrass oil (Cymbopogon spp.), oil of lemon eucalyptus, Litsea cubeba oil, marjoram oil, Melissa oil (lemon balm oil, Melissa officinalis), Mentha spp. oils and extracts (including peppermint oil, peppermint extract, spearmint oil, spearmint extract, watermint oil, corn mint oil, pennyroyal oil, apple mint oil, and oils from Mentha hybrids), mustard oil, myrrh oil, neem oil (neem tree oil), Nepeta spp. oils, nutmeg oil, oregano oil, orris oil, parsley oil, parsley seed oil, patchouli oil, perilla oil, pine oil (Pinus spp.), rose oil, rosehip oil, rose extract, rosemary oil, rosewood oil, sage oil, sandalwood oil (Sandalus spp.), sassafras oil, savory oil (Satureja spp.), spruce oil (Picea spp.), star anise oil, tarragon oil, tea tree oil, thyme oil, vanilla extract, valerian oil, vetiver oil, violet extract, wintergreen oil (oil of wintergreen), wintergreen extract, yarrow oil, and ylang-ylang oil.

As used herein, a “monoterpenoid” refers to ten-carbon compounds derived from two isoprene units via geranyl pyrophosphate. Monoterpenoids may include, for example:
the acyclic monoterpenes, including, for example, α-ocimene, (E)-β-ocimene, (Z)-β-ocimene α-myrcene, or β-myrcene; the monocyclic monoterpenes including d-limonene, l-limonene, α-terpinene, β-terpinene, γ-terpinene, δ-terpinene (terpinolene), α-phellandrene, or β-phellandrene;
the bicyclic monoterpenes, including, for example, α-pinene, β-pinene, bornane, camphene, α-thujene, β-thujene, sabinene, 2-carene, or 3-carene; the acyclic modified monoterpenes, including citronellol, citronellal, citronellic acid, citral, geranial, neral, geraniol, nerol, geranic acid, nerolic acid, linalool, rhodinol, lavandulol, tagatone, myrcenol;
the monocyclic modified monoterpenes, including, for example, menthol, menthone, carveol, carvone, carvonic acid, p-cymene, thymol, carvacrol, thymoquinone, perillyl alcohol, perillaldehyde, perillic acid, perillene, piperitone, pulegone, isopulegone, pulegol, isopulegol, safranal, rose oxide, α-thujalicin, β-thujaplicin, γ-thujaplicin, chrysanthemic acid, crysanthemyl acohol, cuminaldehyde, grandisol, grapefruit mercaptan, hydroxycitronellol, 8-hydroxygeraniol, ipsdienol, menthofuran, p-menthane-3,8-diol, terpinen-4-ol, α-terpineol, β-terpineol, γ-terpineol;
and bicyclic modified monoterpenes, including, for example, camphor, borneol, isoborneol, eucalyptol (1,8-cineol), umbellulone, chrysanthenone, nepetalactone, nepetalactol, verbenol, verbenone, fenchol, fenchone, myrtenol, myrtenal, and wine lactone.

“Monoterpenoid” may also refer to, for example, ester and ether derivatives of other monoterpenoids, especially the formate, acetate, propionate, butyrate, or isobutyrate esters of monoterpenoid alcohols, or the methyl, ethyl, propyl, or isopropyl esters of monoterpenoid acids, or the methyl, ethyl, propyl, or isopropyl ethers of monoterpenoid alcohols, including citronellyl acetate, citronellyl formate, citronellyl propionate, citronellyl isobutyrate, geranyl acetate, neryl acetate, geranyl formate, linalyl acetate, lavandulyl acetate, menthyl acetate, menthyl formate, menthyl propionate, carvyl acetate, thymyl acetate, cavacryl acetate, perillyl acetate, isopulegyl acetate, α-terpinyl acetate, bornyl acetate, verbenyl acetate, fenchyl acetate, thymyl methyl ether, carvacryl methyl ether, thymyl ethyl ether, citronellyl methyl ether, methyl citronellate, ethyl citronellate, methyl geranate, ethyl geranate, and ethyl crysanthemate, and mixtures thereof.

Monoterpenoids containing a single chiral center may exist as a single enantiomer, an enantioenriched mixture of both enantiomers, or as a racemic mix of the two enantiomers. Monoterpenoids containing more than one chiral center may exist as a single enantiomer, an enantioenriched mixture of two enantiomers, a racemic mix of enantiomers, or as a mixture of two or more diastereomers.

As used herein, a “sesquiterpenoid” refers to fifteen-carbon compounds derived from three isoprene units via farnesyl pyrophosphate. Sesquiterpenoids may include, for example, farnesol, nerolidol, α-bisabolol, β-bisabolol, α-bisabolene, β-bisabolene, γ-bisabolene, juvabione, α-curcumene (ar-curcumene), β-curcumene, γ-curcumene, α-tumerone, β-tumerone, zingiberene, curcuphenol, α-cis-bergamotene, β-cis-bergamotene, α-trans-bergamotene, β-trans-bergamotene, curcumol, curcumenone, curcumenol, α-elemene, β-elemene, γ-elemene, δ-elemene, α-elemol, β-elemol, epielemol, β-elemenone, curzerene, curzerenone, cedrol, α-cedrene, β-cedrene, α-eudesmol, β-eudesmol, γ-eudesmol, α-selinene, β-selinene, curdione, germacene A, germacene B, germacene C, germacene D, germacene E, germacrone, α-caryophyllene (α-humulene), β-caryophyllene, caryophyllene oxide, α-cubebene, β-cubebene, cubebol, α-cadinene, β-cadinene, γ-cadinene, δ-cadinene, ϵ-cadinene, α-muurolene, β-muurolene, γ-muurolene, δ-muurolene, ϵ-muurolene, α-amorphene, β-morphene, γ-amorphene, δ-amorphene, ϵ-amorphene, α-bulgarene, β-bulgarene, γ-bulgarene, δ-bulgarene, α-cadinol, β-cadinol, γ-cadinol, δ-cadinol, τ-cadinol, furanodiene, furanodienone, α-guaiene, β-guaiene, γ-guaiene, guaia-6,9-diene, guaiol, guaiazulene, calarene, aromadendrene, allo-aromadendrene, α-copaene, β-copaene, patchoulane, patchouli alcohol, norpatchoulenol, nortetrapatchoulol, β-patchoulene, ledol, α-himachalene, β-himachalene, γ-himachalene, α-santalol, β-santalol, α-santalene, β-santalene, thujopsene, E-α-atlantone, Z-α-atlantone, β-atlantone, γ-atlantone, eudalinol, vetivazulene, vetivalene, α-vetivone, β-vetivone, khusimol, zizanal, epi-zizanal, methyl zizanoal, khusimone, longifolene, isolongifolene, clovene, clovanol, valencene, nootkatone, valerianol, β-burbonene, α-gurjunene, aristolochene, epi-aristolochene, carotol, capsidiol, vetivazulene, spathulenol, viridiflorol, costunolide, and the like. Also included as sesquiterpenoids are sesquiterpenoid alcohol esters and ethers, and volatile sesquiterpenoid derivatives, including methyl cedryl ketone, methyl cedryl ether, cedryl acetate, farnesyl acetate, nerolidyl acetate, bisabolyl acetate, santalyl acetate, guaiyl acetate, and the like.

As used herein, a “phenylpropanoid” refers to secondary plant metabolites derived from, or structurally related to, phenylalanine and tyrosine, including, for example, phenylpropenes, monolignols, monolignans, stilbenes, including salicylic acid or esters or ethers thereof, coumaric acid, cinnamaldehyde, cinnamic acid or esters thereof, cinnamyl alcohol or esters thereof, ferulic acid, eugenol, safrole, isosafrole, piperonal, piperonyl alcohol, sesamol, vanillin, ethylvanillin, vanillyl alcohol, vanillic acid, 2-phenylethanol, apiole, elemicin, methyl eugenol, dillapiole, myristicin, umbelliferone, coniferyl alcohol, estragole, chavicol, or resveratrol. Also included in phenylpropanoids are the ester and ether derivatives of other phenylpropanoids, especially the formate, acetate, propionate, butyrate, or isobutyrate esters of phenylpropanoid alcohols, or the methyl, ethyl, propyl, or isopropyl esters of phenylpropanoid acids, or the methyl, ethyl, propyl, or isopropyl ethers of phenylpropanoid alcohols, including cinnamyl acetate, cinnamyl formate, cinnamyl propionate, methyl cinnamate, ethyl cinnamate, eugenyl acetate, umbelliferone acetate, and piperonyl acetate, 2-phenethylpropionate, and mixtures thereof.

As used herein, a “terpenoid degradation product” refers to a compound derived from a terpenoid through a chemical process, either naturally or synthetically, and includes but is not limited to the carotenoid degradation products α-irone, γ-irone, α-ionone, β-ionone, γ-ionone, α-isomethyl ionone, α-damascone, β-damascone, δ-damascone, α-damascenone, β-damascenone, theaspirane A, theaspirane B, theaspirone A, thiaspirone B, vitaspirane A, and vitaspirone B; labdane diterpenoid-derived sclareolide (CAS Number 564-20-5) and Ambroxide (CAS Number 6790-5-5 or 3738-58-5, variously known as Ambroxan, Ambrox, or Amberlyn), and the various terpene-derived aromatic compounds found in ambergris.

As used herein, unless otherwise specified, “terpene” refers not only to monoterpenoids and sesquiterpenoids sensu stricto derived from isoprene units in the mevalonate pathway (also known as the HMG-CoA reductase pathway or the isoprenoid pathway) or the non-mevalonate pathway (also known as the MEP pathway or the mevalonate-independent pathway), but also phenylpropanoids and terpenoid degradation products, as well as C6-C15 volatile secondary plant metabolites that do not fit into any of the aforementioned categories, including, for example, 3-Z-hexenal, 3-Z-hexenol, 3-Z-hexenyl acetate, jasmolone, jasmonic acid, methyl jasmonate, jasmone, methyl nonyl ketone (2-undecanone), and C6-C15 lactones, including γ-caprolactone, δ-caprolactone, γ-heptalactone, δ-heptalactone, γ-octalactone, 6-octalactone, ϵ-octalactone, γ-nonalactone, δ-nonalactone, ϵ-nonalactone, γ-decalactone, 6-decalactone, ϵ-decalactone, γ-dodecalactone, δ-dodecalactone, ϵ-dodecalactone, 4,5-dimethyl-3-hydroxy-2,5-dihydrofuran-2-one (caramel furanone, sotolon, sugar lactone), 5-ethyl-3-hydroxy-4-methyl-2(5H)-furanone (ethyl fenugreek lactone, maple furanone), 6-pentyl-5,6-dihydropyran-2-one (massoia lactone), 5-butyl-4-methyldihydro-2(3H)-furanone (whiskey lactone), and cyclopentadecanolide (oxacyclohexadecan-2-one, muskalactone).

Some members of this group are used in a wide variety of flavor and fragrance compositions, as well as in extensions of citrus oils. γ-Terpinene is also known as 1-isopropyl-4-methyl-1,4-cyclohexadiene, 4-methyl-1-(1-methylethyl)-1,4-cyclohexadiene, and p-mentha-1,4-diene. α-Terpinene is also known as 4-methyl-1-(1-methylethyl)-1,3-cyclohexadiene. Both α- and γ-terpinene have a lemony fragrance. β-Terpinene, also known as 4-methylene-1-(1-methylethyl) cyclohexene, has been prepared from sabinene. A derivative, terpinene-4-ol, is the primary active ingredient of tea tree oil and the compound of highest concentration in essential oil of nutmeg. Other monoterpene alcohol derivatives of the terpenes include the α-, β-, and γ-terpineol isomers; the α-terpineol isomer is the major component of the naturally isolated terpineol. Other related compounds are terpinolene (4-isopropylidene-1-methyl cyclohexene; p-menth-1,4(8)-diene; 1-methyl-4-(1-methyl ethylidene)cyclohexene; 1-methyl-4-propan-2-ylidene-cyclohexene), and the isomers α-phellandrene and β-phellandrene. Where an embodiment describes the use of γ-terpinene, other embodiments are specifically contemplated in which γ-terpinene may be replaced by other terpinenes or derivatives thereof such as terpinolene, α-phellandrene, β-phellandrene, α-terpinene, β-terpinene, α-terpineol, β-terpineol, γ-terpineol, or terpinene-4-ol, or a mixture of any of these with each other or with γ-terpinene. Where an embodiment describes the use of α-terpinene, other embodiments are specifically contemplated in which α-terpinene may be replaced by other terpinenes or derivatives thereof such as terpinolene, α-phellandrene, β-phellandrene, γ-terpinene, β-terpinene, α-terpineol, β-terpineol, γ-terpineol, or terpinene-4-ol, or a mixture of any of these with each other or with α-terpinene. Where an embodiment describes the use of terpinene-4-ol, other embodiments are specifically contemplated in which terpinene-4-ol may be replaced by other terpinenes or derivatives thereof such as terpinolene, α-phellandrene, β-phellandrene, α-terpinene, β-terpinene, α-terpineol, β-terpineol, γ-terpineol, or γ-terpinene, or a mixture of any of these with each other or with terpinene-4-ol. Where an embodiment describes the use of α-terpineol, other embodiments are specifically contemplated in which α-terpineol may be replaced by other terpinenes or derivatives thereof such as terpinolene, α-phellandrene, β-phellandrene, α-terpinene, β-terpinene, terpinene-4-ol, α-terpineol, β-terpineol, or γ-terpinene, or a mixture of any of these with each other or with α-terpineol. Where an embodiment describes the use of terpinolene, other embodiments are specifically contemplated in which terpinolene may be replaced by other terpinenes or derivatives thereof such as α-terpineol, α-phellandrene, P-phellandrene, α-terpinene, β-terpinene, terpinene-4-ol, β-terpineol, γ-terpineol, or γ-terpinene, or a mixture of any of these with each other or with terpinolene.

Geraniol is a monoterpenoid and an alcohol. It is the primary part of oil-of-rose and palmarosa oil. It is used in perfumes and as a flavoring. It is also produced by the scent glands of honeybees to help them mark nectar-bearing flowers and locate the entrances to their hives. In certain embodiments, where geraniol is employed, it may be mixed with 10%, 20%, 30%, or 40% or more nerol. Commercially obtained geraniol may be designated by the amount of geraniol it contains. For example, a 60/40 mixture of geraniol and nerol is termed “geraniol 60.” Nerol is a monoterpene (C₁₀H₁₈O), the Z-isomer of geraniol, which can be extracted from attar of roses, oil of orange blossoms and oil of lavender. Citral (3,7-dimethyl-2,6-octadienal or lemonal) is the generic name for the aldehyde form of nerol and geraniol, and can be obtained from lemon myrtle, Litsea cubeba, lemongrass, Lemon verbena, lemon balm, lemon, and orange. The E-isomer of citral is known as geranial or citral A. The Z-isomer is known as neral or citral B. Where an embodiment describes the use of any form of geraniol, other embodiments are specifically contemplated in which the geraniol is replaced by another form of geraniol (such as Geraniol Fine FCC or any geraniol/nerol mixture), nerol, geranial, neral, citral, or a mixture of any of these with each other or with any form of geraniol. Similarly, where an embodiment describes the use of any form of citral, other embodiments are specifically contemplated in which the citral is replaced by a form of geraniol (such as Geraniol Fine FCC or any geraniol/nerol mixture), nerol, geranial, neral, or a mixture of any of these with each other or with citral.

Vanillin (also known as methyl vanillin, vanillic aldehyde, vanillin, and 4-hydroxy-3-methoxybenzaldehyde) is the primary component of the extract of the vanilla bean. In addition to vanillin, natural vanilla extract also contains p-hydroxybenzaldehyde, vanillic acid, piperonal, and p-hydroxy-benzoic acid. Synthetic vanillin is used as a flavoring agent in foods, beverages, and pharmaceuticals. Where an embodiment describes the use of vanillin, other embodiments are specifically contemplated in which the vanillin is replaced by natural vanilla extract, p-hydroxybenzaldehyde, vanillic acid, piperonal, ethyl vanillin, or p-hydroxybenzoic acid, or a mixture of any of these with each other or with vanillin.

Methyl salicylate is found in betula oil. Methyl salicylate is a major component of oil of wintergreen and is sometimes referred to interchangeably with oil of wintergreen. It is a natural product of many species of plants, is the methyl ester of salicylic acid, and can be produced chemically from the condensation reaction of salicylic acid and methanol. Some of the plants producing it are called wintergreens, hence the common name. Methyl salicylate can be used by plants as a pheromone to warn other plants of pathogens (Shulaev, et al. (February 1997) Nature 385: 718-721). The release of methyl salicylate can also function as an exopheromone aid in the recruitment of beneficial insects to kill the herbivorous insects (James, et al. (August 2004) J. Chem. Ecol. 30(8): 1613-1628). Numerous plants produce methyl salicylate including species of the family Pyrolaceae and of the genera Gaultheria and Betula. It is noted that, where a given blend or formulation or other composition is disclosed herein as containing wintergreen oil, an alternative embodiment, containing methyl salicylate in place of wintergreen oil, is also contemplated. Likewise, where a blend or formulation of other composition includes methyl salicylate, an alternative embodiment, containing wintergreen oil, is also contemplated.

Wintergreen oil is oil from the shrub genus Gaultheria. Methyl salicylate, the main constituent of the oil, is not present in the plant until formed by enzymatic action from a glycoside within the leaves.

Thyme oil is a natural product that can be extracted from certain plants, including species from the Lamiaceae family; for example, thyme oil can be obtained from Thymus vulgaris (also known as, T. ilerdensis, T. aestivus, and T. velantianus), generally by distillation from the leafy tops and tender stems of the plant. Two commercial varieties of thyme oil are recognized, the ‘red,’ the crude distillate, which is deep orange in color, and the ‘white,’ which is colorless or pale yellow, which is the ‘red’ rectified by re-distilling. Thyme oil principally contains the phenols thymol and carvacrol, along with borneol, linalool, and cymene, and rosmarinic and ursolic acids. Where an embodiment describes the use of thyme oil white, other embodiments are specifically contemplated in which the thyme oil white is replaced by thyme oil red, thymol, carvacrol, borneol, linalool, cymene, rosmarinic acid, ursolic acid, or a mixture of any of these with each other or with thyme oil white. Particularly preferable are mixtures of thyme oil white and thyme oil red that contain 10% or less thyme oil red, more preferably 5% or less, and most preferably 1%.

Thymol is a monoterpene phenol derivative of cymene, C₁₀H₁₄O, isomeric with carvacrol, found in thyme oil, and extracted as a white crystalline substance. It is also known as 3-hydroxy-p-cymene, 5-methyl-2-(1-methyl ethyl)phenol, and 2-isopropyl-5-methylphenol. Where an embodiment describes the use of thymol, other embodiments are specifically contemplated in which the thymol is replaced by carvacrol, thyme oil white, thyme oil red, or a mixture of any of these with each other or with thyme oil white. Carvacrol, also known as 2-hydroxy-p-cymene, 2-methyl-5-(1-methylethyl)phenol, and 5-isopropyl-2-methylphenol, is a colorless liquid substance found in the oil of Origanum vulgare and other plants in family Lamiaceae.

Linalool is a naturally occurring terpene alcohol chemical found in many flowers and spice plants. It is also known as 3,7-dimethyloct-1,6-dien-3-ol. It has two stereoisomeric forms: (S)-(+)-linalool (known as licareol) and (R)-(−)-linalool (known as coriandrol). Linalool can be obtained as linalool coeur (a racemic mixture, CAS number 78-70-6), or in preferred derivative forms such as tetrahydrolinalool (the saturated form), ethyl linalool, linalyl acetate, and pseudo linalyl acetate (7-octen-2-ol, 2-methyl-6-methylene:acetate). Where an embodiment describes the use of any form of linalool, other embodiments are specifically contemplated in which the linalool is replaced by licareol, coriandrol, tetrahydrolinalool, ethyl linalool, linalyl acetate, pseudo linalyl acetate, or a mixture of any of these with each other or with any form of linalool. Similarly, where an embodiment describes the use of tetrahydrolinalool, other embodiments are specifically contemplated in which the tetrahydrolinalool is replaced by licareol, coriandrol, racemic linalool, ethyl linalool, linalyl acetate, pseudo linalyl acetate, or a mixture of any of these with each other or with tetrahydrolinalool. Additionally, where an embodiment describes the use of ethyl linalool, other embodiments are specifically contemplated in which the ethyl linalool is replaced by licareol, coriandrol, tetrahydrolinalool, racemic linalool, linalyl acetate, pseudo linalyl acetate, or a mixture of any of these with each other or with ethyl linalool. Finally, where an embodiment describes the use of linalyl acetate, other embodiments are specifically contemplated in which the linalyl acetate is replaced by licareol, coriandrol, tetrahydrolinalool, racemic linalool, ethyl linalool, pseudo linalyl acetate, or a mixture of any of these with each other or with linalyl acetate.

Lime oil is derived from Citrus aurantifolia (also known as Citrus medica var. acida and C. latifolia) of the Rutaceae family and is also known as Mexican and West Indian lime, as well as sour lime. Its chief constituents are α-pinene, β-pinene, camphene, myrcene, p-cymene, d-limonene, γ-terpinene, terpinolene, 1,8-ceneole, linalool, terpinene-4-ol, α-terpineol, neral, geraniol, neral acetate, geranyl acetate, caryophyllene, trans-α-bergamotene, β-bisabolene, borneol, and citral. It can be obtained in several forms, including Lime Oil 410 (an artificial Mexican-expressed lime oil available from Millennium Specialty Chemicals). Where an embodiment describes the use of any form of lime oil, other embodiments are specifically contemplated in which the lime oil is replaced by α-pinene, β-pinene, camphene, myrcene, p-cymene, d-limonene, γ-terpinene, terpinolene, 1,8-cineole, linalool, terpinene-4-ol, α-terpineol, neral, geraniol, neral acetate, geranyl acetate, caryophyllene, trans-α-bergamotene, β-bisabolene, borneol, or citral, or a mixture of any of these with each other or with any form of lime oil.

Black seed oil is obtained from the seeds of Nigella sativa. Its chief constituents are carvone, α-pinene, sabinene, β-pinene, and p-cymene, as well as the fatty acids myristic acid, palmitic acid, palmitoleic acid, stearic acid, oleic acid, linoleic acid, linolenic acid, and arachidic acid. Where an embodiment describes the use of any form of black seed oil, other embodiments are specifically contemplated in which the black seed oil is replaced by d-carvone, l-carvone, a racemic mixture of d-carvone and l-carvone, α-pinene, sabinene, β-pinene, or p-cymene, or a mixture of any of these with each other, with any of myristic acid, palmitic acid, palmitoleic acid, stearic acid, oleic acid, linoleic acid, linolenic acid, or arachidic acid or with any form of black seed oil.

Piperonal (heliotropine, protocatechuic aldehyde methylene ether, 3,4-methylenedioxybenzaldehyde, piperonyl aldehyde) is an aromatic aldehyde that comes as transparent crystals, C₈H₆O₃, and has a floral odor. It is used as flavoring and in perfume. It can be obtained by oxidation of piperonyl alcohol. Where an embodiment describes the use of piperonal, other embodiments are specifically contemplated in which piperonal may be replaced by piperonyl alcohol, 3,4-methylenedioxybenzylamine, 3,4-methylenedioxymandelonitrile, piperonylic acid, piperonyl acetate, piperonylacetone, piperonylideneacetone, piperonyl isobutyrate, piperonyl butoxide, piperonylglycine, or protocatecheuic acid or a mixture of any of these with each other or with piperonal. Similarly, where an embodiment describes the use of piperonyl alcohol, other embodiments are specifically contemplated in which piperonyl alcohol may be replaced by piperonal, 3,4-methylenedioxybenzylamine, 3,4-methylenedioxymandelonitrile, piperonylic acid, piperonyl acetate, piperonylacetone, piperonylideneacetone, piperonyl isobutyrate, piperonyl butoxide, piperonylglycine, or protocatecheuic acid, or a mixture of any of these with each other or with piperonal.

The pinenes encompass the isomeric forms α-pinene and β-pinene; both are important constituents of pine resin. Important pinene derivatives include the bicyclic ketones verbenone and chrysanthone. Where an embodiment describes the use of α-pinene, other embodiments are specifically contemplated in which α-pinene may be replaced by pinene, verbenone, or chrysanthone, or a mixture of any of these with each other or with α-pinene. Where an embodiment describes the use of β-pinene, other embodiments are specifically contemplated in which β-pinene may be replaced by α-pinene, verbenone, or chrysanthone, or a mixture of any of these with each other or with β-pinene.

Cymene is a monoterpene-related hydrocarbon, consisting of a benzene ring substituted with a methyl group and an isopropyl group. The para-substituted form occurs naturally and is a component of oil of cumin and thyme. The ortho- and met-substituted also exist but are less common. Where an embodiment describes the use of p-cymene, other embodiments are specifically contemplated in which terpinolene may be replaced by o-cymene or m-cymene, or a mixture of any of these with each other or with p-cymene.

As used herein, “water-soluble organic cosolvents” refer to organic solvents that are soluble at a level greater than 1% by volume in water at 20° C., or preferably, greater than 5% by volume in water, including those that are fully miscible. Suitable water-soluble organic solvents include, for example, the alcohols methanol, ethanol, 1-propanol, 2-propanol (isopropyl alcohol), 1-butanol, 2-butanol, isobutanol, tert-butanol, benzyl alcohol, ethylene glycol, 1,2-propanediol (propylene glycol), 1,3-propanediol, 1,2-butanediol, 1,3-butanediol, 1,4-butanediol, 2,3-butanediol, 1,2-pentanediol (pentylene glycol), 1,5-pentanediol, 2-methyl-2,4-pentanediol (hexylene glycol), and glycerin (propane-1,2,3-triol); the glycol ether solvents including 2-methoxyethanol (ethylene glycol methyl ether), 2-ethoxyethanol (ethylene glycol ethyl ether, cellosolve), 2-propoxyethanol (ethylene glycol propyl ether), 2-isopropoxyethanol (ethylene glycol isopropyl ether), 2-butoxyethanol (ethylene glycol butyl ether), 2-phenoxyethanol (ethylene glycol monophenyl ether), 1-methoxy-2-propanol (propylene glycol methyl ether), diethylene glycol, 2-(2-methoxyethoxy)ethanol (diethylene glycol monomethyl ether, methyl carbitol), 2-(2-ethoxyethoxy)ethanol (diethylene glycol monoethyl ether, ethyl carbitol), dipropylene glycol, triethyl citrate, dipropylene glycol monomethyl ether, 1,2-dimethoxyethane (glyme), 1,2-diethoxyethane, 1-methoxy-2-(2-methoxyethoxy)ethane (diglyme), 1-ethoxy-2-(2-ethoxyethoxy)ethane (diethylene glycol diethyl ether), 1,2-bis(2-methoxyethoxy)ethane (triethylene glycol dimethyl ether, triglyme), and 1-methoxy-2-[2-[2-(2-methoxyethoxy)ethoxy]ethoxy]ethane (tetraglyme, tetraethylene glycol dimethyl ether); the organic carbonate esters, including dimethyl carbonate, diethyl carbonate, diphenyl carbonate, ethylene carbonate, propylene carbonate, trimethylene carbonate; and carboxylate esters, including methyl acetate, ethyl formate, ethyl acetate, methyl lactate, ethyl lactate, propyl lactate, isopropyl lactate, butyl lactate, (+)-methyl lactate, (+)-ethyl lactate, (+)-propyl lactate, (+)-isopropyl lactate, and (+)-butyl lactate; also included are acetone, 2-butanone, acetonitrile, sulfolane, dimethyl sulfoxide, N,N-dimethylformamide, N,N-dimethylacetamide, nitromethane, methyl acetate, ethyl formate, ethyl acetate, formic acid, acetic acid, and tetrahydrofuran. “Water-soluble organic cosolvents” may refer to a single suitable solvent, or a combination thereof.

Fatty acids used in the present invention comprise, consist essentially of, or consist of, saturated, monounsaturated, or polyunsaturated, either linear or branched, either substituted or unsubstituted, fatty acids in the range of 6 to 22 carbon atoms.

Suitable linear saturated fatty acids include, for example, hexanoic (caproic), heptanoic (enanthic), octanoic (caprylic), nonanoic (pelargonic), decanoic (capric), undecanoic (undecylic), dodecanoic (lauric), tridecanoic (tridecylic), tetradecanoic (myristic), pentadecanoic (pentadecylic), hexadecenoic (palmitic), heptadecanoic (margaric), octadecanoic (stearic), nonadecanoic, eicoanoic, (arachidic), heneicosanoic, and docosanoic (behenic) acid, and mixtures thereof.

Suitable linear unsaturated fatty acids include, for example, the monousaturated fatty acids including undec-10-enoic (undecylenic), dodec-11-enoic, (Z)-tetradec-9-enoic (myristoleic), (Z)-hexadec-9-enoic (palmitoleic), (Z)-hexadec-6-enoic (sapienic), (Z)-octadec-9-enoic (oleic), (E)-octadec-9-enoic (elaidic), (E)-octadec-11-enoic (vaccenic), (Z)-eicos-9-enoic (gadoleic), (Z)-eicos-11-enoic (eicosenoic), and (Z)-docos-β-enoic (erucic) acid, and mixtures thereof, and the di- and polyunsaturated fats, including (9Z,12Z)-octadeca-9,12-dienoic (linoleic), (9Z,11E)-octadeca-9,11-dienoic (rumenic), (11Z,14Z)-eicosa-11,14-di enoic (eicosadienoic), (9Z,12Z, 15Z)-octadeca-9,12,15-tri enoic (α-linolenic), (6Z,9Z,12Z)-octadeca-6,9,12-trienoic (γ-linolenic), (5Z,9Z,12Z)-octadeca-5,9,12-trienoic (pinolenic), (8E,10E,12Z)-octadeca-8,10,12-trienoic (calendic), (9Z,11E,13 Z)-octadeca-9,11,13-trienoic (punicic), (9Z,11E,13E)-octadeca-9,11,13-trienoic (α-eleostearic), (9E,11E,13E)-octadeca-9,11,13-trienoic (α-eleostearic), (8Z,11Z,14Z)-icosa-8,11,14-trienoic (dihomo-γ-linolenic, DGLA), (5Z,8Z, 11Z,14Z)-icosa-5,8,11,14-tetraenoic (arachidonic), and (6Z,9Z,12Z,15Z)-octadeca-6,9,12,15-tetraenoic (stearidonic) acid, and mixtures thereof.

Suitable branched fatty acids include, for example, 2,2-dimethylbutyric, 3,3-dimethylbutyric, 2-methylpentanoic, 3-methylpentanoic, 4-methylpenanoic, 2-methylhexanoic, 2,2-dimethylpentanoic, 5-methyl hexanoic, 2,2-dimethylhexanoic, 2,3-dimethylhexanoic, 4,4-dimethylhexanoic, 2-ethylhexanoic, 6-methylheptanoic, 3,5,5-trimethylhexanoic, 7-methyloctanoic, 8-methylnonanoic, 9-methyl-decanoic, 10-methylundecanoic, 11-methyldodecanoic, 12-methyltridecanoic, β-methyltetradecanoic acid, 14-methylpentadecanoic, 15-methylhexadecanoic, and 16-methylheptadecanoic acid, and mixtures thereof.

Fatty acids may also be substituted, particularly with hydroxyl groups. Suitable substituted fatty acids include, for example, (9Z,12R)-12-hydroxyoctadec-9-enoic (ricinoleic) acid and the ω-hydroxy acids, such as 0-hydroxydecanoic, 16-hydroxypalmitic, and 18-hydroxystearic acid, and mixtures thereof.

As used herein, the term “surfactant” refers specifically to anionic surfactants, including, for example, the organosulfates, such as sodium dodecyl sulfate (sodium lauryl sulfate, SDS, SLS), potassium dodecyl sulfate, ammonium dodecyl sulfate, sodium decyl sulfate, sodium octyl sulfate, sodium laureth sulfate, sodium myreth sulfate, sodium pareth sulfonate; the organosulfonates, including one or more of the isomeric linear or branched sodium dodecylbenzenesulfonates, sodium decylbenzensulfonates, sodium octylbenzenesulfonates, and sodium bis(2-ethylhexyl) sulfosuccinate (docusate sodium); the isethionates, including sodium butyl isethionate, sodium capryloyl isethionate, sodium caproyl isethionate, sodium lauroyl isethionate, and sodium palmitoyl isethionate; and the suitable sodium, potassium, ammonium, or amine salts of a fatty acid; or a combination thereof.

As used herein, the term “fats” refers to solid or liquid lipid materials derived from an organism comprising essentially of triglycerides, including both natural lipid materials and those that have undergone additional processes after extraction, including, for example, hydrogenation, partial hydrogenation, refining, degumming, bleaching, deodorizing, and the like. “Vegetable oil” refers to solid and/or liquid fats derived from plants, while “animal fat” refers to solid and/or liquid fats from animal sources. Suitable vegetable oils include, for example, palm oil, soybean oil, rapeseed oil (canola oil), sunflower seed oil, peanut oil, cottonseed oil, palm kernel oil, coconut oil, olive oil, corn oil, grape seed oil, hazelnut oil, linseed oil, rice bran oil, safflower oil, sesame oil, brazil nut oil, carapa oil, almond oil, avocado oil, cocoa butter, hemp seed oil, mustard oil, walnut oil, castor oil, wheat oil, wheat germ oil, hydrogenated castor oil, hydrogenated cottonseed oil, hydrogenated rapeseed oil, hydrogenated soybeen oil, hydrogenated palm oil, and the like. Suitable animal fats include, for example, lard, tallow, chicken fat, emu oil, fish oil, cod liver oil, whale oil, and the like.

In some embodiments, a mixture of fatty acids or fatty acid salts (soaps) derived from a fat may be used. Suitable fatty acid or fatty acid salt mixtures include, for example, sodium cocoate, potassium cocoate, sodium tallowate, potassium tallowate, ammonium tallowate, sodium palm kernelate, fatty acid mixtures produced by the hydrolysis of triacylglycerides, fatty acid salts produced by the saponification of triacylglycerides, fatty acid salts produced by the saponification of animal fats, fatty acid salts produced by the saponification of vegetable oils, and mixtures thereof.

Suitable amines for making amine salts of fatty acids include, for example, methylamine, ethylamine, dimethylamine, diethylamine, isopropylamine, aminomethylpropanol, monoethanolamine, diethanolamine, dimethylethanolamine, N-methylethanolamine, 3-amino-1,2-propanediol, methyldiethanolamine, 2-amino-2-methyl-1,3-propanediol, bis(2-hydroxypropyl)amine (diisopropanolamine), tris(2-hydroxypropyl)amine (triisopropanolamine), and triethanolamine, and combinations thereof.

As used herein, the term “acylglycerol-derived emulsifiers” refers to nonionic surfactants, detergents, wetting agents, emulsifiers, foaming agents, or dispersants chemically derived from the esterification of least one glycerol unit and at least one fatty acid, such that at least one glycerol hydroxyl group is not esterified. As used herein, the term “polyglycerol fatty acid monoester” refers to acylglycerol-derived emulsifiers with more than one glycerol unit and exactly one fatty acid ester. As used herein, the term “polyglycerol fatty acid multi-ester” refers to acylglycerol-derived emulsifiers with more than one glycerol unit and more than one fatty acid ester. Suitable acylglycerol-derived emulsifiers include, for example, glycerol monolaurate (monolaurin, 2,3-dihydroxypropyl dodecanoate), glycerol dilaurate (dilaurin), glycerol monodecanoate (monocaprin, monodecanoyl glycerol, 2,3-dihydroxypropyl decanoate), monomyristin (monotetradecanoyl glycerol, 2,3-dihydroxypropyl tetradecanoate), monopalmitin (monohexadecanoyl glycerol, 2,3-dihydroxypropyl hexadecanoate), polyglycerol octanoate, polyglycerol decanoate, polyglycerol dodecanoate (polyglycerol laurate), polyglycerol tetradecanoate (polyglycerol myristate), polyglycerol hexadecanoate (polyglycerol palmitate), polyglycerol octadecanoate (polyglycerol stearate), polyglycerol oleate, polyglyceryl-2 caprate, polyglyceryl-2 caprylate, polyglyceryl-2 laurate, polyglyceryl-2 myristate, polyglyceryl-2 isopalmitate, polyglyceryl-2 palmitate, polyglyceryl-2 isostearate, polyglyceryl-2 oleate, polyglyceryl-2 stearate, polyglyceryl-3 caprate, polyglyceryl-3 caprylate, polyglyceryl-3 laurate, polyglyceryl-3 myristate, polyglyceryl-3 palmitate, polyglyceryl-3 isostearate, polyglyceryl-3 oleate, polyglyceryl-3 stearate, polyglyceryl-3 ricinoleate, polyglyceryl-4 caprate, polyglyceryl-4 caprylate, polyglyceryl-4 laurate, polyglyceryl-4 isostearate, polyglyceryl-4 oleate, polyglyceryl-4 stearate, polyglyceryl-5 caprate, polyglyceryl-5 laurate, polyglyceryl-5 myristate, polyglyceryl-5 isostearate, polyglyceryl-5 oleate, polyglyceryl-5 stearate, polyglyceryl-5 ricinoleate, polyglyceryl-6 caprate, polyglyceryl-6 caprylate, polyglyceryl-6 undecylenate, polyglyceryl-6 laurate, polyglyceryl-6 myristate, polyglyceryl-6 palmitate, polyglyceryl-6 isostearate, polyglyceryl-6 oleate, polyglyceryl-6 stearate, polyglyceryl-6 ricinoleate, polyglyceryl-8 oleate, polyglyceryl-8 stearate, polyglyceryl-10 caprate, polyglyceryl-10 caprylate, polyglyceryl-10 undecylenate, polyglyceryl-10 laurate, polyglyceryl-10 myristate, polyglyceryl-10 palmitate, polyglyceryl-10 isostearate, polyglyceryl-10 linoleate, polyglyceryl-10 oleate, polyglyceryl-10 stearate, polyglyceryl-4 dilaurate, polyglyceryl-4 pentaoleate, polyglyceryl-4 distearate, polyglyceryl-4 tristearate, polyglyceryl-4 pentastearate, polyglyceryl-5 dicaprylate, polyglyceryl-5 dilaurate, polyglyceryl-5 trimyristate, polyglyceryl-5 pentamyristate, polyglyceryl-5 triisostearate, polyglyceryl-5 dioleate, polyglyceryl-5 trioleate, polyglyceryl-5 tristearate, polyglyceryl-5 hexastearate, polyglyceryl-6 sesquicaprylate, polyglyceryl-6 dicaprate, polyglyceryl-6 tricaprylate, polyglyceryl-6 tetracaprylate, polyglyceryl-6 pentacaprylate, polyglyceryl-6 heptacaprylate, polyglyceryl-6 octacaprylate, polyglyceryl-6 dipalmitate, polyglyceryl-6 sesquiisostearate, polyglyceryl-6 diisostearate, polyglyceryl-6 dioleate, polyglyceryl-6 tetraoleate, polyglyceryl-6 pentaoleate, polyglyceryl-6 hexaoleate, polyglyceryl-6 sesquistearate, polyglyceryl-6 distearate, polyglyceryl-6 tristearate, polyglyceryl-6 pentastearate, polyglyceryl-6 hexastearate, polyglyceryl-6 octastearate, polyglyceryl-6 pentaricinoleate, polyglyceryl-6 tetrabehenate, and combinations thereof.

Acylglycerol-derived emulsifiers vary in their affinity for water and oil depending on the number of glycerol and fatty acid units present in the emulsifier molecules, with the affinity for the oil phase increasing as the ratio of fatty acid units to glycerol units increases, and also as the length of the fatty acid chain increases. It is desirable for the compositions of the present invention to contain at least one acylglycerol-derived emulsifier with a higher affinity for the oil phase than the water phase, as this reduces interfacial surface tension of the oil phase and thereby stabilizes the microemulsion.

As used herein, “microemulsion system” shall refer to the combination of at least one water-soluble organic solvent, at least one acylglycerol-derived emulsifier, and at least one surfactant. The present inventors observed that the combination of these three components in specific ratio ranges permit the formation of clear, thermodynamically-stable microemulsion of oils in water.

In some embodiments, the addition of an antioxidant compound may be desirable to reduce autoxidation of components of the formulation or of any emulsified oil or other component. Suitable antioxidants include, for example, ascorbic acid (vitamin C), sodium ascorbate, potassium ascorbate, calcium ascorbate, ascorbyl palmitate, fatty esters of ascorbic acid, tocopherols, α-tocopherol, β-tocopherol, γ-tocopherol, δ-tocopherol, α-tocotrienol, β-tocotrienol, γ-tocotrienol, δ-tocotrienol, tocopherol esters, tocopherol acetates, tocopherol succinates, butylated hydroxytoluene (BHT), 2,6-di-tert-butylphenol, butylated hydroxyanisole (BHA), 2,4-dimethyl-6-tert-butylphenol, hydroquinone, and 6-ethoxy-2,2,4-trimethyl-1,2-dihydroquinoline (ethoxyquin, EMQ), and combinations thereof.

In some embodiments, the adjustment of the pH of the emulations may be desirable, for example, for reasons of emulsion kinetic stability, emulsified compound stability, thermal stability, and microbial growth inhibition. The pH of the emulsion may be lowered through the addition of a suitable acid or buffer, including, for example, hydrochloric acid, sulfuric acid, phosphoric acid, sodium dihydrogenphosphate, potassium dihydrogen phosphate, acetic acid, vinegar, propionic acid, citric acid, monosodium citrate, monopotassium citrate, calcium citrate, ammonium citrate, ammonium ferric citrate, benzoic acid, formic acid, succinic acid, malic acid, sodium malate, potassium malate, calcium malate, magnesium malate, fumaric acid, sodium fumarate, potassium fumarate, calcium fumarate, magnesium fumarate, maleic acid, lactic acid, sodium lactate, potassium lactate, calcium lactate, magnesium lactate, tartaric acid, sodium tartrate, potassium tartrate, calcium tartrate, magnesium tartrate, adipic acid, sodium adipate, potassium adipate, ascorbic acid (vitamin C), carbon dioxide, carbonic acid, and glyoxylic acid, and combinations thereof. The pH of the emulsion may be raised through the addition of a suitable base of buffer, including, for example, sodium carbonate, potassium carbonate, sodium bicarbonate, ammonium carbonate, ammonium acetate, sodium acetate, potassium acetate, calcium acetate, magnesium acetate, sodium citrate, trisodium citrate, monopotassium citrate, tripotassium citrate, calcium citrate, ammonium citrate, triammonium citrate, ammonium ferric citrate, sodium benzoate, potassium benzoate, ammonium benzoate, sodium malate, potassium malate, calcium malate, magnesium malate, sodium fumarate, potassium fumarate, calcium fumarate, magnesium fumarate, sodium lactate, potassium lactate, calcium lactate, magnesium lactate, tartrate, potassium tartrate, sodium potassium tartrate, calcium tartrate, magnesium tartrate, sodium adipate, potassium adipate, sodium ascorbate, sodium hydroxide, and potassium hydroxide, disodium hydrogenphosphate, dipotassium hydrogenphosphate, trisodium phosphate, tripotassium phosphate, sodium borate, and mixtures thereof.

In some embodiments, the addition of a preservative may be desirable to prevent microbial growth. Suitable preservatives include, for example, benzoic acid, ammonium benzoate, sodium benzoate, potassium benzoate, calcium benzoate, magnesium benzoate, salts of benzoic acid, ammonium acetate, boric acid, sodium borate, borax, sodium bisulfite, potassium bisulfite, magnesium bisulfite, calcium bisulfite, sodium sulfite, potassium sulfite, magnesium sulfite, calcium sulfite, sodium metabisulfite, potassium metabisulfite, sodium nitrate, potassium nitrate, sodium nitrite, potassium nitrite, ethylenediaminetetraacetic acid (EDTA), disodium EDTA, calcium disodium EDTA, tetrasodium EDTA, salts of EDTA, calcium formate, sorbic acid, sodium sorbate, potassium sorbate, calcium sorbate, magnesium sorbate, salts of sorbic acid, dimethyl carbonate, methyl paraben, ethyl paraben, propyl paraben, butyl paraben, isobutyl paraben, heptyl parapen, parabens, sodium methyl paraben, sodium ethyl paraben, sodium salts of parabens, potassium salts of parabens, formaldehyde, formic acid, sodium formate, potassium formate, calcium formate, magnesium formate, salts of formic acid, hexamine, acetic acid, sodium acetate, potassium acetate, calcium acetate, magnesium acetate, salts of acetic acid, and sulfur dioxide, chlorhexidine, polyhexidine, polyaminopropyl biguanidine, benzalkonium chloride, stearalkonium chloride, cetalkonium chloride, Quaternium-15, quarternary ammonium salts, triclosan, thiomersal, 2-methyl-4-isothiazolin-3-one, 5-chloro-2-methyl-4-isothiazolin-3-one, benzisothiazolinone, 1,3-bi s(hydroxymethyl)-5,5-dimethylimidazolidine-2,4-dione (DMDM hydantoin), diazolidinyl urea, imidazolidinyl urea, thiabendazole (tiabendazole), and combinations thereof.

As used herein, the term “fatty alcohol” refers not only to the analogs of fatty acids wherein the carboxylic acid moiety (—COOH) is replaced by a carbinol moiety (—CH₂OH), but also to the C23-C40 straight-chain primary alcohols, including, for example, 1-tricosanol, 1-tetracosanol, 1-pentacosanol, 1-hexacosanol, 1-heptacosanol, 1-octacosanol, 1-nonacosanol, 1-triacontanol (myricyl alcohol or melissyl alcohol), 1-dotriacontanol, and 1-tetratriacontanol.

As used herein, the term “non-acylglycerol-derived emulsifiers” refers to surfactants, detergents, wetting agents, emulsifiers, foaming agents, or dispersants that are not derived from the esterification of one or more fatty acids with one or more glycerol units. Embodiments of the invention can include the addition of a non-acylglycerol-derived emulsifier.

As used herein, the term “viscosity modifier” refers to compounds, polymers, or additives that increase or decrease the viscosity of the microemulsion. In some embodiments, the inclusion of a viscosity modifier to adjust viscosity may be desirable. Viscosity modifiers may be used, for example, to increase the kinetic stability of a microemulsion and/or to improve the aesthetics, wetting properties, and/or film-forming properties of the formulation. In some embodiments, an acylglycerol-derived emulsifier also acts as a viscosity modifier. In some embodiments, a non-acylglycerol-derived emulsifier also acts as a viscosity modifier.

Many additives can serve as viscosity modifiers and/or non-acylglycerol-derived emulsifiers. Compounds suitable for use as non-acylglycerol-derived emulsifiers and/or viscosity modifiers include, for example, the polysorbates, including polysorbate 20, polysorbate 40, polysorbate 60, and polysorbate 80; sorbitan esters including sorbitan monolaurate, sorbitan monosterate, and sorbitan tristate; lecithins; oligomers, polymers, copolymers, block copolymers, and cross polymers of polyethylene glycol, polypropylene glycol, polyvinylpyrrolidone, polyacrylates, poloxamers (triblock copolymers of the form poly(ethylene oxide)-block-poly(propylene oxide)-block-poly(ethylene oxide)); PEGylated fatty acids, acylglycerols, fatty alcohols, and waxes, including PEG-8 beeswax, PEG-7 glyceryl cocoate, PEG-8 cocoate, PEG-8 glyceryl isosterate, PEG-8 isosterate, PEG-8 distearate, PEG-8 laurate (octaethylene glycol monododecyl ether), PEG-5 laurate (pentaethylene glycol monododecyl ether), PEG-40 hydrogenated castor oil, PEG-80 glyceryl stearate, PEG-150 distearate, ceteareth-20 (ethoxylated C16-18 alcohols, with 20:1 ethylene oxide:fatty alcohol average ratio), ceteareth-25 (ethoxylated C16-18 alcohols, with 25:1 ethylene oxide:fatty alcohol average ratio), isoceteth-20 (polyethylene glycol isocetyl ether; ethoxylated cetyl alcohol with 20:1 ethylene oxide:cetyl alcohol average ratio), and triethylene glycol monolauryl ether (Laureth-3); ethylene glycol; propylene glycol; glycerol; fatty alcohols; fatty acids; esters produced by the esterification of a fatty acids with a fatty alcohol, including cetyl palmitate, triacontyl palmitate, and behenyl behenate; beeswax; carnauba wax; natural or modified mono-, oligo, and polysaccharides including agar, alginic acid, sodium alginate, calcium alginate, β-glucans, arrowroot, carob gum, carrageenan, cassia gum, chitosan, cellulose, cellulose acetate, cellulose carboxymethyl ether and its anionic salts, maltodextrin, pyrodextrins, dextrins, galactomannans, gellan gum, glucomannans, guar gum, gum arabic, gum tragacanth, locust bean gum, xanthan gum, pectin, polydextrose, potato starch, hydroxyethyl cellulose, hydroxypropyl cellulose, hydroxypropyl methyl cellulose, methylcellulose, sorbitol, hydrolyzed starch; chondrin; collagen; gelatins; fatty acid amides, including cocoamide DEA (cocoamide diethanolamine), cocoamide MEA (cocoamide monoethanolamine), cocoamidopropyl betaine, lauramide diethanolamine, lauramide monoethanolamine, aryl alkyl polyoxyethylene glycols, lauryl glucoside, nonoynols, nonoxynol-9, octoxynols, and octoxynol-9 (Triton X-100), and combinations thereof.

In some embodiments, it is desirable for the viscosity of an RTU product containing the microemulsion system to be between 0.9 and 250 cP, preferably between 1 and 150 cP, and more preferably between 5 and 100 cP. Formulations with viscosities between 250 and 1000 cP are also envisioned in this invention.

Triethyl citrate (also known as citric acid, triethyl ester; TEC; ethyl citrate; 2-hydroxy-1,2,3-propanetricarboxylic acid, triethyl ester; and Citroflex 2) is used as a high boiling solvent and plasticizer for vinyl resins and cellulose acetates. It is a plasticizer permitted in the field of food additives, food contact materials, medicines, and pharmaceuticals. Where an embodiment describes the use of triethyl citrate, other embodiments are specifically contemplated in which triethyl citrate may be replaced by other citrate plasticizer esters such as tributyl citrate, acetyl tributyl citrate and tri-(2-ethylhexyl)-citrate, or a mixture of any of these with each other or with triethyl citrate.

Isopropyl myristate is the ester of isopropanol and myristic acid; it is also known as 1-tetradecanoic acid, methylethyl ester; myristic acid isopropyl ester; and propan-2-yl tetradecanoate. Where an embodiment describes the use of isopropyl myristate, other embodiments are specifically contemplated in which isopropyl myristate may be replaced by similar chemicals such as isopropyl palmitate, isopropyl stearate, isostearyl neopentonate, myristyl myristate, decyl oleate, octyl sterate, octyl palmitate, isocetyl stearate, or PPG myristyl propionate, or a mixture of any of these with each other or with isopropyl myristate. Isopropyl myristate may also be used as a thickening agent and emollient.

As used herein, “active component” shall refer to the one or more substances that, together or separately, provide a desired function. Active components may include water-soluble or oil-soluble pesticidal compounds or substances, pharmaceutical compounds, cosmetics, nutraceuticals, cleaning agents, dyes, pigments, lubricants, fertilizers, coatings, waxes, plant essential oils, synergists, wetting agents, spreading agents, antifoaming agents, fragrances, terpenes, flavorings, and combinations thereof.

In some embodiments, the active components for controlling pests and methods for preparing and using these compositions can include compounds that are generally regarded as safe (GRAS compounds). In some embodiments, the compositions can include compounds of a plant origin, such as plant essential oils or terpenes of plant essential oils.

As used herein, “water-immiscible phase” shall refer to the one or more solid or liquid substances that, together or separately, are neither fully miscible in a liquid state, nor sufficiently soluble to fully dissolve in water.

In various embodiments of the composition of the present invention, the ratio of surfactant to acylglycerol-derived emulsifier, on a by-weight basis, may vary from 1000:1 to 1:1000, preferably 100:1 to 1:100, more preferably, 20:1 to 1:20, and most preferably, 10:1 to 1:10.

In some embodiments, the ratio of the total mass percentage of the microemulsion system to active component may vary from 1000:1 to 1:2, preferably 100:1 to 2:3, more preferably 25:1 to 1:1, and most preferably, 10:1 to 1:1.

In some embodiments, the ratio of the total mass percentage of the microemulsion system to active component may vary from 10:1 to 1:20, preferably 5:1 to 1:15, and most preferably, 2:1 to 1:10.

In various embodiments of the composition of the present invention, the concentration of surfactant, on a by-weight basis as a percentage of the total weight of the formulation, may vary from 0.1% to 60%, preferably 0.1% to 30%, and most preferably 0.5% to 20%.

In various embodiments of the composition of the present invention, the concentration of acylglycerol-derived emulsifier, on a by-weight basis as a percentage of the total weight of the formulation, may vary from 0.1% to 50%, preferably 0.1% to 30%, and most preferably 0.5% to 20%.

In various embodiments of the composition of the present invention, the total concentration of water soluble organic solvent, on a by-weight basis as a percentage of the total weight of the formulation, may vary from 0.1% to 50%, preferably 0.1% to 30%, and most preferably 0.5% to 20% in RTU formulations, and 1% to 99%, preferably 10% to 99%, and most preferably 15% to 90% in emulsifiable concentrates intended to be diluted in water.

Surprisingly, by blending certain compounds in certain relative amounts, the resulting composition demonstrates a repellant or pesticidal effect that exceeds the repellant or pesticidal effect of any component of the composition.

Surprisingly, by combining certain pest control chemicals, and compounds or blends of the present invention, pest control activity of the resulting compositions can be enhanced, i.e., a synergistic effect on pest control activity is achieved when a certain chemical or chemicals, and a certain compound or compounds are combined. In other words, the compositions including certain combinations of at least one chemical, and at least one compound or at least one blend of compounds can have an enhanced ability to control target pests, as compared to each of the chemicals or compounds taken alone.

Some fatty acids, particularly C8-C14 fatty acids, possess herbicidal activity on their own; additionally, some terpenes and plant essential oils are also herbicidal. The combination of a suitably herbicidal fatty acid, preferably a C8-C14 fatty acid, more preferably a C10-C12 fatty acid, used together with a plant essential oil and a terpene, produce a synergistic herbicidal effect.

Lauric acid (also known as dodecanoic acid, dodecylic acid, or laurostearic acid) is a saturated fatty acid with a 12-carbon atom chain and is found naturally in coconut oil, palm kernel oil, and laurel oil. Lauric acid is a low-odor white solid at room temperature. The combination of lauric acid and at least one essential oil or terpene appears to provide a synergistic increase in efficacy against various pests.

In certain embodiments of the present invention, “synergy” can refer to any substantial enhancement, in a combination of at least two ingredients, of a measurable effect, when compared with the effect of one active ingredient alone, or when compared with the effect of the complete combination minus at least one ingredient. Synergy is a specific feature of a combination of ingredients and is above any background level of enhancement that would be due solely to, e.g., additive effects of any random combination of ingredients. Effects include but are not limited to repellant effect of the composition; pesticidal effect of the composition; perturbation of a cell message or cell signal such as, e.g., calcium, cyclic-AMP, and the like; and diminution of activity or downstream effects of a molecular target.

As used herein, “synergy” and “synergistic effect” can refer to any substantial enhancement, in a composition of at least two compounds, of a measurable effect, e.g., an antiparasitic, pesticidal, or herbicidal effect, when compared with the effect of a component of the composition, e.g., one active compound alone, or the complete blend of compounds minus at least one com-pound. Synergy is a specific feature of a blend of compounds and is above any background level of enhancement that would be due solely to, e.g., additive effects of any random combination of ingredients.

In some embodiments, a substantial enhancement of a measurable effect can be expressed as a coefficient of synergy. A coefficient of synergy is an expression of a comparison between measured effects of a composition and measured effects of a comparison composition. The comparison composition can be a component of the composition. In some embodiments, the synergy coefficient can be adjusted for differences in concentration of the complete blend and the comparison composition.

Synergy coefficients can be calculated as follows. An activity ratio (R) can be calculated by dividing the % effect of the composition (A_{B}) by the % effect of the comparison composition (Xₙ), as follows:

R=A_{B}/Xₙ (Formula 1)

A concentration adjustment factor (F) can be calculated based on the concentration (Cₙ), i.e., % (wt/wt) or % (vol/vol), of the comparison composition in the composition, as follows:

F=100/Cₙ (Formula 2)

The synergy coefficient (S) can then be calculated by multiplying the activity ratio (R) and the concentration adjustment factor (F), as follows:

S=(R)(F) (Formula 3)

As such, the synergy coefficient (S) can also by calculated, as follows:

S=[(AB/Xₙ)(100)]/Cₙ (Formula 4)

In Formula 4, AB is expressed as % effect of the blend, Xₙ is expressed as % effect of the comparison composition (Xₙ), and Cₙ is expressed as % (wt/wt) or % (vol/vol) concentration of the comparison composition in the blend.

In some embodiments, a coefficient of synergy of about 1.1, 1.2, 1.3, 1.4, or 1.5 can be substantial and commercially desirable. In other embodiments, the coefficient of synergy can be from about 1.6 to about 5, including but not limited to about 1.8, 2.0, 2.5, 3.0, 3.5, 4.0, and 4.5. In other embodiments, the coefficient of synergy can be from about 5 to 50, including but not limited to about 10, 15, 20, 25, 30, 35, 40, and 45. In other embodiments, the coefficient of synergy can be from about 50 to about 500, or more, including but not limited to about 50, 75, 100, 125, 150, 200, 250, 300, 350, 400, and 450. Any coefficient of synergy above 500 is also contemplated within embodiments of the compositions.

Given that a broad range of synergies can be found in various embodiments described herein, it is expressly noted that a coefficient of synergy can be described as being “greater than” a given number and therefore not necessarily limited to being within the bounds of a range having a lower and an upper numerical limit. Likewise, in some embodiments described herein, certain low synergy coefficients, or lower ends of ranges, are expressly excluded. Accordingly, in some embodiments, synergy can be expressed as being “greater than” a given number that constitutes a lower limit of synergy for such an embodiment. For example, in some embodiments, the synergy coefficient is equal to or greater than 25; in such an embodiment, all synergy coefficients below 25, even though substantial, are expressly excluded.

In some embodiments, synergy or synergistic effect associated with a composition can be determined using calculations similar to those described in Colby, S. R., “Calculating Synergistic and Antagonistic Responses of Herbicide Combinations,” Weeds, 1967 15:1, pp. 20-22, which is incorporated herein by reference. In this regard, the following formula can be used to express percent effect (E) of a composition including two compounds, Compound X and Compound Y:

E=X+Y−(X*Y/100) (Formula 5)

In Formula 5, X is the measured actual percent effect of Compound X in the composition, and Y is the measured actual percent effect of Compound Yin the composition. The expected percent effect (E) of the composition is then compared to a measured actual percent effect (A) of the composition. If the actual percent effect (A) that is measured differs from the expected percent effect (E) as calculated by the formula, then the difference is due to an interaction of the compounds. Thus, the composition has synergy (a positive interaction of the compounds) when A>E. Further, there is a negative interaction (antagonism) when A<E.

Formula 5 can be extended to account for any number of compounds in a composition; however it becomes more complex as it is expanded, as is illustrated by the following formula for a composition including three compounds, Compound X, Compound Y, and Compound Z:

E=X+Y+Z−((XY+XZ+YZ/100)+(X*Y*Z/1000) (Formula 6)

An easy-to-use formula that accommodates compositions with any number of compounds can be provided by modifying Formulas 5 and 6. Such a modification of the formula will now be described. When using Formulas 5 and 6, an untreated control value (untreated with composition or compound) is set at 100%, e.g., if the effect being measured is the amount of target insects killed, the control value would be set at 100% survival of the target insect. In this regard, if treatment with compound A results in 80% killing of the target insect, then the treatment with compound A can be said to result in a 20% survival, or 20% of the control value. The relationship between values expressed as a percent effect and values expressed as a percent-of-control are set forth in the following formulas, where E′ is the expected percent of control of the composition, Xₙ is the measured actual % effect of an individual compound (Compound Xₙ) of the composition, Xₙ′ is the percent of control of an individual compound of the composition, and A′ is the actual measured percent of control of the composition.

X=100−E′ (Formula 7)

Xₙ=100−Xₙ′ (Formula 8)

A=100−A′ (Formula 9)

By substituting the percent-of-control values for the percent effect values of Formulas 5 and 6, and making modifications to accommodate any number (n) of compounds, the following formula is provided for calculating the expected % of control (E′) of the composition:

$${E}^{′} = ( {\prod }_{i = 1}^{n} {X}_{i}^{′} ) \div {100}^{n - 1} \qquad ( Formula 10 )$$

According to Formula 10, the expected % of control (E′) for the composition is calculated by dividing the product of the measured actual % of control values (Xₙ′) for each compound of the composition by 100ⁿ⁻¹. The expected % of control (E′) of the composition is then compared to the measured actual % of control (A′) of the composition. If the actual % of control (A′) that is measured differs from the expected % of control (E′) as calculated by Formula 10, then the difference is due to an interaction of the compounds. Thus, the composition has synergy (a positive interaction of the compounds) when A′<E′. Further, there is a negative interaction (antagonism) when A′>E′.

Compositions containing two or more compounds in certain ratios or relative amounts can be tested for a synergistic effect by comparing the pesticidal effect of a particular composition of compounds to the pesticidal effect of a component of the composition. Additional information related to making a synergy determination can be found in the examples set forth in this document. While synergy has been described in terms of a coefficient of synergy and in terms of the Colby synergy calculations, it is noted that synergy by other measures or determinations known in the art is, in some embodiments, also within the meaning of synergy as described and claimed herein.

Exemplary methods that can be used to determine the synergistic effect of a particular composition are set forth in the following paterts and published applications, each of which is incorporated in its entirety herein by reference: U.S. Pat. No. 7,541,155, entitled METHODS OF SCREENING COMPOSITIONS FOR POTENTIAL INSECT CONTROL ACTIVITY; U.S. Pat. No. 7,622,269, entitled METHODS OF SCREENING TYRAMINE-AND OCTOPAMINE-EXPRESSING CELLS FOR COMPOUNDS AND COMPOSITIONS HAVING POTENTIAL INSECT CONTROL ACTIVITY; U.S. Patert Application Publication No. 2006-0263403 A1, entitled METHODS OF SCREENING COMPOUNDS FOR INSECT-CONTROL ACTIVITY INVOLVING THE TYRAMINE RECEPTOR; and U.S. Patert Application Publication No. 2008-0075796 A1, entitled COMPOSITIONS FOR CONTROLLING INSECTS.

Embodiments of the invention can include an herbicidal chemical or product. In some embodiments, these herbicidal chemicals can include, for example, amide herbicides (dicryl, chloranocryl, pentanochlor, propanil, and the like), benzamides, (including tebutam and the like), anilide herbicides, arylalanine herbicides, acetamides (diphenamid, naproanilide, napropamide, and the like), α-chloroacetamide herbicides (acetochlor, alachlor, allidochlor (CDAA), butachlor, butenachlor, delachlor, diethatyl, diethatyl-ethyl, dimethachlor, dimethenamid, metazachlor, metolachlor, pethoxamid, pretilachlor, propachlor, propisochlor, prynachlor, thenylchlor, and the like), α-oxyacetamide herbicides (flufenacet, mefenacet, and the like), benzamines (propyzamide, pronamide, and the like), sulfonanilide herbicides, trifluoromethanesulfonanilides (mefluidide, perfluidone, and the like), sulfonamide herbicides (pyrimisulfan, triafamone, and the like), thioamide herbicides, antibiotic herbicides, aryl carboxylate herbicides (difludenzopyr, diflufenzopyr-sodium, naptalam, and the like), benzoic acid herbicides (DCPA, chlorthal-dimethyl, chloramben, dicamba, 2,3,6-trichlorobenzoic acid, and the like), pyrimidinyl benzoate herbicides (bispyribac, bispyribac-sodium, pyribenzoxim, pyriftalid, pyriminobac, pyriminobac-methyl, pyrithiobac, pyrithiobac-sodium, and the like), triazolo carboxamidine herbicides (flupoxam and the like), azolyl carboxamide herbicides (cafenstrole, fentrazamide, ipfencarbazone, and the like), pyrimidinylthiobenzoic acid herbicides, phthalic acid herbicides, N-phenyl imide herbicides (butafenacil, chlorphthalim, cinidon, cinidon-ethyl, flumiclorac, flumiclorac-pentyl, flumioxazin, flumipropyn, pentoxazone, saflufenacil, tiafenacil, trifludimoxazin, fluthiacet, fluthiacet-methyl, and the like), N-phenyl heterocycle herbicides (flurochloridone, norflurazone, and the like), N-phenyl oxadiazolone herbicides (oxadiargyl, oxadiazon, and the like), N-phenyl triazolinone herbicides (azafenidin, carfentrazone, carfentrazone-ethyl, sulfentrazone, and the like), pyridyloxy carboxylates (fluroxypyr, triclopyr, and the like), picolinic acid herbicides (aminopyralic, clopyralid, florpyrauxifen, halauxifen, picloram, and the like), quinolinecarboxylic acid herbicides (quinclorac, quinmerac and the like), arsenical herbicides (cacodylic acid, copper(II) arsenate, disodium methylarsonate, monosodium methanearsonate and the like), benzofuranyl alkylsulfonate herbicides, benzothiazole herbicides, carbamate herbicides (asulam, barban, carbeamide, chlorbufam, chlorpropham, propham, swep (methyl N-(3,4-dichlorophenyl)carbamate), and the like), carbanilate herbicides, cyclohexene oxime herbicides, cyclopropylisoxazole herbicides, dicarboximide herbicides, dinitroaniline herbicides (benefin, benflualin, butralin, dinitramine, ethalfluralin, fluchloralin, isopropalin, nitralin, oryzalin, pendimethalin, prodiamine, profluralin, trifluralin, and the like), dinitrophenol herbicides (DNOC (4.6-dinitro-ortho-cresol), dinosam, dinoseb, dinoterb, etinofen, medinoterb, and the like), diphenyl ether herbicides (acifluorfen, aclonifen, bifenox, chlomethoxyfen, chlornitrofen, fluorodifen, fluoroglycofen, fluoroglycofen-ethyl, fluoronitrofen, fomesafen, lactofen, nitrofen, oxyfluorfen, and the like), nitrophenyl ether herbicides, dithiocarbamate herbicides, halogenated aliphatic herbicides, phenyl ether herbicides (beflubutamid, diflufenican, picolinafen, and the like), benzyl ether herbicides (cinmethylin, methiozolin, and the like), imidazolinone herbicides (imazamethabenz, imazamethabenz-methyl, imazamox, imazapic, imazapyr, imazaquin, imazethapyr, and the like), isoxazolidinones (bixlozone, clomazone, and the like), inorganic herbicides, nitrile herbicides (chlorthiamide, dichlobenil, bromofenoxim, bromoxynil, ioxynil, and the like), organophosphorus herbicides (anilofos, bensulide, piperophos, butamifos, DMPA, glyphosate, bialaphos, bilanafos, glufosinate, glufosinate-ammonium, and the like), oxadiazolone herbicides, phenyl carboxylate herbicides (chlorfenac, fenac, chlorfenprop, and the like), phenoxy carboxylate herbicides (2,4-dichlorophenoxyacetic acid (2,4-D), 2,4,5-trichlorophenoxyacetic acid (2,4,5-T), 4-(2,4-dichlorophenoxy)butyric acid (2,4-DB), clomeprop, dichlorprop, fenoprop, 2-methyl-4-chlorophenoxyacetic acid (MCPA), 4-(4-chloro-2-methylphenoxy)butanoic acid (MCPB), mecoprop, and the like), aryloxyphenoxypropionic herbicides (clodinafop, clodinafop-propargyl, clofop, cyhalofop, cyhalofop-butyl, diclofop, diclofop-methyl, fenoxaprop, fenoxaprop-ethyl, fenthiaprop, fluazifop, fluazifop-butyl, haloxyfop, haloxyfop-methyl, isoxapyrifop, metamifop, quizalofop, quizalofop-ethyl, and the like), phenylenediamine herbicides, pyrazole herbicides (pyrasulfotole, tolpyralate, topramezone, benzofenap, pyrazolynate, pyrazoxyfen, and the like), benzoylpyrazole herbicides, phenylpyrazole herbicides (pyraflufen, pyraflufen-ethyl, and the like), phenylpyrazoline herbicides (pinoxaden and the like), pyridazine herbicides (pyridate and the like), pyridazinone herbicides (chlorprocarb, desmedipham, phenisopham, phenmedipham, and the like), phenoxypyridazine herbicides (cyclopyrimorate and the like), pyridine herbicides (dithiopyr, thiazopyr, and the like), pyridinium herbicides (cyperquat, diquat, morfamquat, paraquat, and the like), pyrimidinediamine herbicides, quaternary ammonium herbicides, thiocarbamate herbicides (butylate, cycloate, dimepiperate, EPTC (S-ethyl dipropylthiocarbamate), esprocarb, molinate, orbencarb, pebulate, prosulfocarb, thiobencarb, benthiocarb, tiocarbazil, tri-allate, vernolate, and the like), thiocarbonate herbicides, thiourea herbicides, triazine herbicides (indaziflam, triaziflam, ametryne, atraton, atrazine, aziprotryn, CP 17029 (Lambast), chlorazine, cyanazine, cyprazine, desmetryne, dimethametryn, dipropetryn, eglinazine, eglinazine-ethyl, ipazine, methoprotryn, procyazine, proglinazine, proglinazine-ethyl, prometon, prometryne, propazine, sebuthylazine, secbumeton, simazine, simetryne, terbumeton, terbuthylazine, terbutryne, trietazine, and the like), alkyl azine herbicides, chlorotriazine herbicides, methoxytriazine herbicides, methylthiotriazine herbicides, triazinone herbicides (ethiozin, hexazinone, isomethiozin, metamitrol, metribuzin, and the like), triazolinone herbicides (amicarbazone and the like), triazole herbicides (amitrole and the like), benzothiadiazinone herbicides (bentazon and the like), triazolopyrimidineherbicides, uracil herbicides (bromacil, isocil, lenacil, terbacil, and the like), urea herbicides (benzthiazuron, bromuron, buturon, chlorbromuron, chlorotoluron, chloroxuron, difenoxuron, dimefuron, diuron, ethidimuron, fenuron, fluometuron, fluothiuron, isoproturon, isouron, linuron, methabenzthiazuron, metobenzuron, metobromuron, metoxuron, monolinuron, monuron, neburon, parafluron, siduron, tebuthiuron, thiazafluron, and the like), phenylurea herbicides, sulfonylurea herbicides (amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-Na, foramsulfuron, halosulfuron, halosulfuron-methyl, imazosulfuron, iodosulfuron, iodosulfuron-methyl-Na, mesosulfuron, mesosulfuron-methyl, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, trifloxysulfuron-Na, triflusulfuron, triflusulfuron-methyl, tritosulfuron, and the like), triazolinone herbicides (flucarbazone, flucarbazone-Na, propoxycarbazone, prop oxy c arb azole-Na, thiencarbazone, thiencarbazone-methyl, and the like), triazolopyrimidine herbicides (chloransulam, chloransulam-methyl, diclosulam, florasulam, flumetsulam, metosulam, penoxsulam, pyroxsulam, and the like), diphenyl heterocycle herbicides (furidone, flurtamone, and the like), benzofuran herbicides (benfuresate, ethofumesate, and the like), isoxazaline herbicides (fenoxasulfone, pyroxasulfone, and the like), oxirane herbicides (indanofan, tridiphane, and the like), arylaminopropionic acid herbicides (flamprop-m and the like), chlorocarbonic acid herbicides (dalapon, flupropanate, TCA (trichloroacetic acid), and the like), isoxazole herbicides (isoxaflutole and the like), triketone herbicides (bicyclopyrone, fenquinotrione, mesotrione, sulcotrione, tefuryltrione, tembotrione, benzobicyclon, and the like), pyrimidinylsulfonylurea herbicides, triazinylsulfonylurea herbicides, thiadiazolylurea herbicides, diphenyl heterocyclic herbicides (furidone, flurtamone, and the like), benzoylcyclohexanedione herbicides, cyclohexanedione herbicides (alloxydim, butroxydim, clethodim, cloproxydim, cycloxydim, profoxydim, sethoxydim, tepraloxydim, tralkoxydim, and the like), and unclassified herbicides (benazolin, benzolin ethyl, pyraclonil, endothal, bromobutide, cumyluron, DSMA, difenzoquat, dymron, etobenzanid, fosamine, MSMA, methyldymron, monalide, oleic acid, oxaziclomefone, pelargonic acid, pyributicarb, quinoclamine, and the like).

Embodiments of the invention can include an insect control chemical. In some embodiments of the invention, the insect control chemical can include, for example, an organophosphate compound, a carbamate compound, a chlorphenoxy compound, a carbazate compound, a neonicotinoid compound, an organochlorine compound, an organotin compound, an oxadiazine compound, a pyridazinone compound, a pyrethroid, a tetrazine compound, or the like. In some embodiments of the invention, the insect control chemical can include, for example, an insect repellent, a biologically-based insecticide, a carbamate compound, an organophosphate compound, a cyclodiene organochlorine compound, a phenylpyrazole (fiprole) compound, a pyrethroid, a pyrethrin, a diarylcarbinol compound, a neonicotinoid compound, a sulfoximine compound, a butenolide compound, a mesoionic insecticidal compound, a spinosyn, a macrocyclic glutamate-gated chloride channel modulator, a juvenile hormone mimic, a chitin biosynthesis-disrupting compound, a microbial disruptor of insect midgut membranes, an inhibitor of insect mitochondrial ATP synthase, an uncoupler of insect oxidative phosphorylation, a compound that blocks the nicotinic acetylcholinesterase receptor, a molting-disrupting compound, an octopamine receptor agonist, a mitochondrial electron transport inhibitor, a voltage-dependent sodium channel blocker, an inhibitor of acetyl coenzyme A carboxylase, a ryanodine receptor modulator, a chordotonal organ modulator compound, a GABA-gated chloride channel modulator compound, or the like, or an insect control compound of unknown or uncertain mode of action.

Insect repellents can include, for example, plant essential oils, terpenes, pyrethroids, pyrethrins, IR3535® (3-[N-butyl-N-acetyl]-aminopropionic acid ethyl ester), methyl nonyl ketone, metofluthrin, neem oil, nepetalactone, oil of lemon eucalyptus, permethrin, picaridin, p-menthane-3,8-diol, DEET (N,N-diethyl-m-toluamide), and the like. Biologically-based insecticides include, for example, plant essential oils, terpenes, natural macrocyclic glutamate-gated chloride channel modulators, spinosyns, proteins and/or spores from Bacillus thuringiensis or B. sphaericus, living or dead B. thuringiensis or sphaericus cultures, baculoviruses such as Cydia pomonella granulovirus, Thaumatotibia leucotreta granulovirus, Anticarsia gemmatalis nucleopolyhedrovirus, Helicoverpa armigera multiple nucleopolyhedrovirus and other granuloviruses or nucleopolyhedroviruses, Burkholderia spp., Wolbachie pipientis, Beauvaria bassiana strains, Metarhizium anisopliae strains, Paecilomyces fumosoroseus strains, and the like. Carbamate insect control compounds include, for example, alanycarb, aldicarb, bendiocarb, benfuracarb, butocarboxim, butoxycarboxim, carb aryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC, xylylcarb, and the like. Organophosphate insect control compounds include, for example, acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isoxathion, malathion, mecarbam, methamidophos, methidathion, mevinphos, monocrotophos, naled, omethoate, oxydemeton-methyl, parathion, parathion-methyl, phenthoate, phosalone, phorate, phosmet, phosphamidon, phoxim, profenofos, propetamphos, prothiofos, pyraclofos, pyridaphenthion, pirimiphos, pirimiphos-ethyl, pirimiphos-methyl, quinalphos, sulfotep, tebupirimfos, temephos, terbufos, tetrachlorvinphos, thiometon, triazophos, trichlorfon, vamidothion, isopropyl O-(methoxyaminothio-phosphoryl) salicylate, and the like. Cyclodiene organochlorine compounds include, for example, aldrin, chlordane, dieldrin, endosulfan, heptachlor, toxaphene, and the like. Phenylpyrazole (fiprole) compounds include, for example, acetoprole, ethiprole, fipronil, flufiprole, pyraclofos, pyrafluprole, pyriprole, pyrolan, vaniliprole, and the like. Pyrethroids include, for example, acrinathrin, allethrin, d-cis-trans allethrin, d-trans allethrin, bifenthrin, bioallethrin, S-cyclopentenyl bioallethrin, bioresmethrin, cycloprothrin, cyfluthrin, β-cyfluthrin, cyhalothrin, X-cyhalothrin, γ-cyhalothrin, cypermethrin, α-cypermethrin, β-cypermethrin, θ-cypermethrin, ζ-cypermethrin, cyphenothrin [(1R)-trans-isomers], deltamethrin, empenthrin [(EZ)-(1R)-isomers], esfenvalerate, etofenprox, fenpropathrin, fenvalerate, flucythrinate, flumethrin, t-fluvalinate, kadathrin, pyrethrins (pyrethrum), halfenprox, metofluthrin, phenothrin [(1R)-trans-isomer], prallethrin, resmethrin, silafluofen, tefluthrin, tetramethrin, tetramethrin [(1R)-isomers], tralomethrin, transfluthrin, permethrin, and the like. Pyrethrins include, for example, natural pyrethrum, Chrysanthemum cinerariaefolium extract, pyrethrin I, cinerin I, jasmolin I, pyrethrin II, cinerin II, jasmolin II, and the like. Diarylcarbinol compounds include, for example, DDT, difluorodiphenyltrichloroethane, methoxychlor, dicofol, and the like. Neonicotinoid compounds include, for example, nicotine, acetamiprid, clothianidin, dinotefuran, imidacloprid, nitenpyram, nithiazine, thiacloprid, thiamethoxam, and the like. Sulfoximine compounds include, for example, sulfoxaflor and the like. Butenolide compounds include, for example, flupyradifurone and the like. Mesoionic insecticidal compounds include, for example, triflumezopyrim and the like. Spinosyns include, for example, spinosad, spinocyn A, spinocyn C, spinetoram, and the like. Macrocyclic glutamate-gated chloride channel modulators include, for example, ivermectin, abamectin, avermectin B₁ₐ, avermectin B_{1b}, selamectin, doramectin, emamectin benzoate, milbemectin, lipmectin, milbemectin A3, milbemectin A4, and the like. Juvenile hormone mimics include, for example, hydroprene, kinoprene, methoprene, fenoxycarb, pyriproxyfen, and the like. Chitin biosynthesis-disrupting compounds include, for example, clofentezine; diflovidazin; hexythiazox; etoxazole; benzoylureas including bistrifluron, chlorfluazuron, diflubenzuron, flucycloxuron, flufenoxuron, hexaflumuron, lufenuron, novaluron, noviflumuron, teflubenzuron, and triflumuron; buprofezin; and the like. Inhibitors of insect mitochondrial ATP synthase include, for example, diafenthiuron, azocyclotin, cyhexatin, fenbutatin oxide, propargite, tetradifon, and the like. Uncouplers of oxidative phosphorylation include, for example, chlorfenapyr, 4,6-dinitro-o-cresol (DNOC), sulfuramid, and the like. Nicotinic acetylcholine receptor channel blockers include, for example, bensultap, cartap, cartap hydrochloride, thiocyclam, tiosultap, thiosultap-sodium, and the like. Molting-disrupting compounds include, for example, cyromazine; ecdysone receptor agonists including chromafenozide, halofenozide, methoxyfenozide, and tebufenozide. Octopamine receptor agonists include, for example, amitraz, chlordimeform, and the like. Mitochondrial electron transport inhibitors include, for example, hydrmethylnon, acequinocyl, fluacrypyrim, byfenazate, fenazaquin, fenpyroximate, pyrimidifen, pyridaben, tebufenpyrad, tolfenpyrad, rotenone, cyenopyrafen, cyflumetofen, pyflubumide, and the like. Voltage-dependent sodium channel blockers include, for example, indoxacarb, metaflumizone, and the like. Inhibitors of acetyl coenzyme A carboxylase include, for example, spirodiclofen, spiromesifen, spiropidion, spirotetramat, and the like. Ryanodine receptor modulators include, for example, chlorantraniliprole, cyantraniliprole, cyclaniliprole, flubendiamide, tetraniliprole. and the like. Chordotonal organ modulators include, for example, flonicamid, pyridine azomethine derivatives such as pymetrozine and pyrifluquinazon, pyropenes such as afidopyropen, and the like. GABA-gated chloride channel modulators include, for example, broflanilide, fluxametamide, fluralanaer, afoxalaner, lotilaner, and the like. Insect control compound of unknown or uncertain mode of action include, for example, azadirachtin, benzoximate, bromopropylate, chinomethionat, dicofol, pyridalyl, and the like.

Certain embodiments of the invention can include, for example, the combination of an insect control chemical with a plant essential oil. The combination of some insecticides with at least one plant essential oil appears to produce a synergistic increase in efficacy against various insect pests.

Certain embodiments of the invention can include, for example, a fungicidal chemical or product. In some embodiments, these fungicidal chemicals can include, for example, aliphatic nitrogen fungicides, amide fungicides, acylamino acid fungicides, anilide fungicides, benzanilide fungicides, biological fungicides, furanilide fungicides sulfonanilide fungicides, benzamide fungicides, furamide fungicides, phenylsulfamide fungicides, sulfonamide fungicides, valinamide fungicides, antibiotic fungicides, strobilurin fungicides, aromatic fungicides, benzimidazole fungicides, benzimidazole precursor fungicides, benzothiazole fungicides, bridged diphenyl fungicides, carbamate fungicides, benzimidazolylcarbamate fungicides, carbanilate fungicides, conazole fungicides, copper fungicides, dicarboximide fungicides, dichlorophenyl dicarboximide fungicides, phthalimide fungicides, dinitrophenol fungicides, dithiocarbamate fungicides, imidazole fungicides, inorganic fungicides, mercury fungicides, morpholine fungicides, organophosphorus fungicides, organotin fungicides, oxathin fungicides, oxazole fungicides, polysulfide fungicides, pyrazole fungicides, pyridine fungicides, pyrimidine fungicides, pyrrole fungicides, quinoline fungicides, quinone fungicides, quinoxaline fungicides, thiazole fungicides, thiazolidine fungicides, thiocarbamate fungicides, thiophene fungicides, triazine fungicides, triazole fungicides, urea fungicides, unclassified fungicides, and the like. In some embodiments, fungicidal chemicals can include, for example, acibenzolar-S-methyl, aldimorph, ametoctradin, amisulbrom, anilazine, azaconazole, azoxystrobin, Bacillus amyloliquefaciens strain D747, Bacillus amyloliquefaciens strain FZB24, Bacillus amyloliquefaciens strain MBI600, Bacillus amyloliquefaciens strain QST 713, Bacillus mycoides isolate J, benalaxyl, benalaxyl-M, benodanil, benomyl, benthiavalicarb, benzovindiflupyr, binapacryl, biphenyl, bitertanol, bixafen, blasticidin-S, boscalid, bromuconazole, bupirimate, captafol, captan, carbendazim, carboxin, carpropamid, cell walls of Saccharomyces cerevisiae strain LAS117, chinomethionat, chloroneb, chlozolinate, copper salts, coumoxystrobin, cyazofamid, cyflufenamid, cymoxanil, cyproconazole, cyprodinil, dichlofluanid, diclocymet, diclomezine, dicloran, diethofencarb, difenoconazole, diflumetorim, dimethachlone, dimethirimol, dimethomorph, dimoxystrobin, diniconazole, dinocap, dithianon, dodemorph, dodine, edifenphos, enoxastrobin, epoxiconazole, etaconazole, ethaboxam, ethirimol, etridiazole, eugenol, extract from Melaleuca alternifolia (tea tree), extract from Reynoutria sachalinensis (giant knotweed), famoxadone, fenamidone, fenaminstrobibin, fenarimol, fenazaquin, fenbuconazole, fenfuram, fenhexamid, fenoxanil, fenpiclonil, fenpicoxamid, fenpropidin, fenpropimorph, fenpyrazamine, fentin acetate, fentin chloride, fentin hydroxide, ferbam, ferimzone, fluazinam, fludioxonil, flufenoxystrobin, fluindapyr, flumorph, fluopicolide, fluopimomide, fluopyram, fluoroimide, fluoxastrobin, fluquinconazole, flusilazole, flusulfamide, flutianil, flutolanil, flutriafol, fluxapyroxad, folpet, fosetyl-A1, fthalide, fuberidazole, furalaxyl, furametpyr, geraniol, Gliocladium catenulatum strain J1446, guazatine, hexaconazole, hymexazole, imazalil, imibenconazole, iminoctadine, inpyrfluxam, iodocarb, ipconazole, iprobenfos, iprodione, iprovalicarb, isofetamid, isoflucypram, isoprothiolane, isopyrazam, isotianil, kasugamycin, kresoxim-methyl, laminarin, mancozeb, mandestrobin, mandipropamid, maneb, mefentrifluconazole, mepanipyrim, mepronil, meptyldinocap, metalaxyl, metalaxyl-M, metconazole, methasulfocarb, metiram, metominostrobin, metrafenone, myclobutanil, naftifine, natamycin (pimaricin), nuarimol, octhilinone, ofurace, orysastrobin, oxadixyl, oxathiapiprolin, oxolinic acid, oxpoconazole, oxycarboxin, oxytetracycline, pefurazoate, penconazole, pencycuron, penflufen, penthiopyrad, phenamacril, phosphorous acid and salts, picarbutrazox, picoxystrobin, piperalin, polyoxin, probenazole, prochloraz, procymidone, propamocarb, propiconazole, propineb, proquinazid, prothiocarb, prothioconazole, pydiflumetofen, pyraclostrobin, pyrametostrobin, pyraoxystrobin, pyraziflumid, pyrazophos, pyribencarb, pyributicarb, pyrifenox, pyrimethanil, pyrimorph, pyriofenone, pyrisoxazole, pyroquilon, quinomethionate, quinoxyfen, quintozene, sedaxane, silthiofam, simeconazole, spiroxamine, Streptomyces griseovirides strain K61, streptomycin, sulfur, tebuconazole, tebufloquin, teclofthalam, tecnazene, terbinafine, tetraconazole, thiabendazole, thifluzamide, thiophanate, thiophanate-methyl, thiram, thymol, tiadinil, tolclofos-methyl, tolfenpyrad, tolprocarb, tolylfluanid, triadimefon, triadimenol, triazoxide, Trichoderma asperellum strain T34, Trichoderma atroviride strain 1-1237, Trichoderma atroviride strain LU132, Trichoderma atroviride strain SC1, triclopyricarb, tricyclazole, tridemorph, trifloxystrobin, triflumizole, triforine, triticonazole, validamycin, valifenalate, vinclozolin, zinc thiazole, zineb, ziram, zoxamide, and the like.

Certain embodiments of the invention can include, for example, one or more ingredients on the 25(b) list of active ingredients that can be used in pesticide products that are exempt from the Federal Insecticide, Fungicide, and Rodenticide Act (FIFRA) under the Minimum Risk Exemption regulations in 40 CFR 152.25(f), the entire text whereof is incorporated by reference into the present application. In some embodiments, those ingredients can include, for example, castor oil, cedarwood oil, cinnamon, cinnamon oil, citric acid, citronella, citronella oil, cloves, clove oil, corn gluten meal, corn oil, cornmint, cornmint oil, cottonseed oil, dried blood, eugenol, garlic, garlic oil, geraniol, geranium oil, lauryl sulfate, lemongrass oil, linseed oil, malic acid, peppermint, peppermint oil, 2-phenylethyl propionate, potassium sorbate, putrescent whole egg solids, rosemary, rosemary oil, sesame, sesame oil, sodium chloride, sodium lauryl sulfate, soybean oil, spearmint, spearmint oil, thyme, thyme oil, white pepper, and zinc.

Certain embodiments of the invention can include, for example, one or more ingredients on the 4(a) list of inert ingredients that can be used in pesticide products that are exempt from the Federal Insecticide, Fungicide, and Rodenticide Act (FIFRA) under the Minimum Risk Exemption regulations in 40 CFR 152.25(f), the entire text whereof is incorporated by reference into the present application. In some embodiments, those ingredients can include, for example, acetyl tributyl citrate, agar, almond oil, alpha-cyclodextrin, aluminatesilicate, aluminum magnesium silicate, aluminum potassium sodium silicate, aluminum silicate, aluminum sodium silicate, ammonium benzoate, ammonium stearate, amylopectin acid-hydrolyzed 1-octenylbutanedioate, amylopectin hydrogen 1-octadecenylbutanedioate, ascorbyl palmitate, attapulgite-type clay, beeswax, bentonite, bentonite sodium, bet-cyclodextrin, (+)-butyl lactate, butyl lactate, butyl stearate, calcareous shale, calcite, calcium acetate, calcium acetate monohydrate, calcium benzoate, calcium carbonate, calcium citrate, calcium octanoate, calcium oxide silicate, calcium silicate, calcium stearate, calcium sulfate, calcium sulfate, dihydrate, calcium sulfate hemihydrate, canary seed, carbon, carbon dioxide, carboxymethyl cellulose, carnauba wax, carob gum, carrageenan, caseins, castor oil, castor oil hydrogenated, cellulose, cellulose acetate, cellulose mixture with cellulose carboxymethyl ether sodium salt, cellulose pulp, cellulose regenerated, citric acid, citric acid monohydrate, corn cobs, cotton, decanoic acid monoester with 1,2,3-propanetriol, dextrins, diglyceryl monooleate, diglyceryl monostearate, dilaurin, dipalmitin, dipotassium citrate, disodium citrate, disodium sulfate, dodecanoic acid monoester with 1,2,3-propanetriol, (+)-ethyl lactate, gamma-cyclodextrin, glycerin, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, glyceryl stearate, humic acid, hydroxyethyl cellulose, hydroxylpropyl cellulose, hydroxypropyl methyl cellulose, isopropyl alcohol, isopropyl myristate, lauric acid, lecithins, linseed oil, magnesium carbonate, magnesium benzoate, magnesium oxide, magnesium oxide silicate, magnesium silicate, magnesium silicate hydrate, magnesium silicon, magnesium stearate, magnesium sulfate, magnesium sulfate heptahydrate, malic acid, maltodextrin, methylcellulose, mineral oil, 1-monolaurin, 1-monomyristin, monomyristin, monopalmitin, monopotassium citrate, monosodium citrate, myristic acid, nitrogen, octanoic acid potassium salt, octanoic acid sodium salt, oleic acid, palm oil, palmitic acid, paraffin wax, pectin, perlite, polyethylene, polyglyceryl oleate, polyglyceryl stearate, potassium acetate, potassium aluminum silicate, potassium benzoate, potassium bicarbonate, potassium chloride, potassium citrate, potassium humate, potassium myristate, potassium oleate, potassium ricinoleate, potassium sorbate, potassium stearate, potassium sulfate, 1,2-propylene carbonate, silica, silicic acid magnesium salt, soap, sodium acetate, sodium alginate, sodium benzoate, sodium bicarbonate, sodium carboxymethyl cellulose, sodium chloride, sodium citrate, sodium humate, sodium humatte, sodium oleate, sodium ricinoleate, sodium stearate, sodium sulfate, sorbitol, soya lecithins, stearic acid, sulfur, tetraglyceryl monooleate, tricalcium citrate, triethyl citrate, tripotassium citrate, trisodium citrate, urea, vanillin, vermiculite, vinegar, vitamin C, vitamin E, white mineral oil, wintergreen oil, xanthan gum, zeolites, zinc iron oxide, zinc oxide, and zinc stearate.

Table 1 lists components, corresponding total contert ranges (preferred, in percent weight of the total formulation), total mass percentage ratios (preferred), and certain additional characteristics for various non-limiting embodiments of RTU formulations according to the present disclosure. It will be understood that the components, contert ranges, ratios, and further particulars listed in Table 1 are exemplary and are not necessarily limiting of the invention of the present disclosure.

TABLE 1

| | | More | Even More |
|---|---|---|---|
| | Preferred | Preferred | Preferred |
| RTU formulation component | Range | Range | Range |
| Anionic surfactant (for example, one or more of | 0.1% to 60% | 0.1% to 30% | 0.5% to 20% |
| sodium dodecyl sulfate, ammonium dodecyl sulfate, | | | |
| sodium decyl sulfate, sodium octyl sulfate, sodium | | | |
| laureth sulfate, sodium myreth sulfate, sodium | | | |
| dodecylbenzenesulfonate, sodium bis(2- | | | |
| ethylhexyl)sulfosuccinate, sodium laurate, potassium | | | |
| laurate, ammonium laurate, sodium octanoate, | | | |
| sodium decanoate, sodium myristate, potassium | | | |
| decanoate, potassium stearate, and sodium 3,5,5- | | | |
| trimethylhexanoate) | | | |
| Acylglycerol-derived emulsifier (for example, one or | 0.1% to 50% | 0.1% to 30% | 0.5% to 20% |
| more of glycerol decanoate, diglyceryl monooleate, | | | |
| diglyceryl monostearate, dilaurin, dipalmitin, | | | |
| glycerol monolaurate, glycerol monooleate, glycerol | | | |
| dicaprylate, glycerol dimyristate, glycerol dioleate, | | | |
| glycerol distearate, glycerol monomyristate, glycerol | | | |
| monooleate, glycerol monostearate, glycerol | | | |
| stearate, 1-monolaurin, 1-monomyristin, | | | |
| monomyristin, monopalmitin, polyglycerol oleate, | | | |
| polyglycerol stearate, and tetraglycerol monooleate) | | | |
| Total mass percentage ratio of anionic surfactant to | 100:1 to 1:100 | 20:1 to 1:20 | 10:1 to 1:10 |
| acylglycerol-derived emulsifier | | | |
| Organic water-soluble solvent (for example, one or | 0.1% to 50% | 0.1% to 30% | 0.5% to 20% |
| more of propylene carbonate, ethylene carbonate, | | | |
| methanol, ethanol, 1-propanol, 2-propanol, t- | | | |
| butanol, 1-butanol, sec-butanol, iso-butanol, | | | |
| ethylene glycol, triethyl citrate, propylene glycol, | | | |
| diethylene glycol, (+)-butyl lactate, butyl lactate, | | | |
| (+)-ethyl lactate, ethyl lactate, glycerin, glyme, and | | | |
| acetone) | | | |
| Total mass percentage ratio of microemulsion | 100:1 to 1:1.5 | 25:1 to 1:1 | 10:1 to 1:1 |
| system to water-insoluble component | | | |
| Fatty acid (for example, one or more of octanoic | 0% to 15% | 0% to 10% | 0% to 7% |
| acid, nonanoic acid, decanoic acid, lauric acid, | | | |
| myristic acid, palmitic acid, stearic acid, linoleic | | | |
| acid, oleic acid, 3,5,5-trimethylhexanoic acid, 7- | | | |
| methylnonanoic acid, and linolenic acid) | | | |
| pH modifier (for example, one or more of calcium | 0 to 6% | 0 to 5% | 0 to 4% |
| acetate, calcium acetate monohydrate, calcium | | | |
| carbonate, calcium citrate, citric acid, citric acid | | | |
| monohydrate, dipotassium citrate, disodium citrate, | | | |
| magnesium oxide, monopotassium citrate, | | | |
| monosodium citrate, potassium acetate, potassium | | | |
| bicarbonate, potassium citrate, sodium acetate, | | | |
| sodium bicarbonate, sodium citrate, tricalcium | | | |
| citrate, trisodium citrate, tripotassium citrate, | | | |
| tripotassium citrate monohydrate, trisodium citrate | | | |
| dihydrate, trisodium citrate pentahydrate, vinegar, | | | |
| acetic acid, citric acid, and malic acid) | | | |
| pH range | 2 to 12 | 3 to 10 | 3 to 9 |
| Preservative (for example, one or more of potassium | 0% to 3% | 0% to 2% | 0 to 1% |
| sorbate, sodium sorbate, ammonium benzoate, | | | |
| calcium benzoate, magnesium benzoate, potassium | | | |
| benzoate, sodium benzoate, benzoic acid, methyl | | | |
| paraben, ethyl paraben, DMDM hydantoin, 2- | | | |
| methyl-4-isothiazolin-3-one, benzalkonium chloride, | | | |
| EDTA, disodium EDTA) | | | |
| Antioxidant (for example, one or more of ascorbic | 0% to 3% | 0% to 2% | 0 to 1% |
| acid, tocopherols, vitamin E, BHT, BHA, EMQ, | | | |
| sodium ascorbate, potassium ascorbate, ascorbyl | | | |
| palmitate) | | | |
| Terpenes (for example, one or more of eugenol, | 0% to 10% | 0% to 8% | 0 to 6% |
| nootkatone, geraiol, nerol, 2-phenethyl propionate, | | | |
| citronellol, citral, citronellal, cinnamaldehyde, | | | |
| thymol, carvacrol, menthol, geranyl acetate, linalool, | | | |
| α-pinene, limonene, carveol, and carvone) | | | |
| Plant essential oil (or example, one or more of | 0% to 10% | 0% to 8% | 0 to 6% |
| cedarwood oil (China), cedarwood oil (Texas), | | | |
| cedarwood oil (Virginia), cinnamon oil, citronella | | | |
| oil, clove oil, cornmint oil, garlic oil, geranium oil, | | | |
| lemongrass oil, licorice extract, oregano oil, | | | |
| peppermint oil, rosemary oil, spearmint oil, thyme | | | |
| oil, wintergreen oil) | | | |
| Viscosity modifier/emulsifier (for example, one or | 0% to 5% | 0% to 3% | 0% to 2% |
| more of agar, acid-hydrolyzed amylopectin 1- | | | |
| octenylbutanedioate, amylopectin hydrogen 1- | | | |
| octenylbutanedioate, carboxymethyl cellulose, carob | | | |
| gum, carrageenan, cellulose acetate, sodium salt of | | | |
| cellulose carboxymethyl ether, cellulose, citrus | | | |
| pectin, gelatin, gellan gum, guar gum, gum Arabic, | | | |
| gum tragacanth, hydroxyethyl cellulose, | | | |
| hydroxypropyl cellulose, hydroxypropyl methyl | | | |
| cellulose, sodium alginate, sodium carboxymethyl | | | |
| cellulose, hydrogenated hydrolyzed starch syrups) | | | |
| Herbicide (for example, one or more of glyphosate, | 0% to 5% | 0% to 3% | 0% to 2% |
| glufosinate, 2,4-D, dicamba, MCPA, trichlopyr, | | | |
| fluroxypyr, halosulfuron-methyl, mesotrione, diquat, | | | |
| quinclorac, diuron, imazapyr, imazaquin, prometon, | | | |
| atrazine, dithiopyr, isoxaben, trifluralin, prodiamine, | | | |
| carfentrazone-ethyl, mecoprop-P, fluazifop-P-butyl, | | | |
| bispyribac, bromacil, chlorimuron-ethyl, clopyralid, | | | |
| cloransulam-methyl, sulfentrazone, simazine, | | | |
| norflurazon, quizalofop, topramezone) | | | |
| Insecticide (for example, one or more of abamectin, | 0% to 5% | 0% to 3% | 0% to 2% |
| bifenthrin, allethrin, cyfluthrin, λ-cyhalothrin, | | | |
| deltamethrin, DDVP, naled, fipronil, carbaryl, | | | |
| imidacloprid, chlorantraniliprole, hydroprene, | | | |
| methoprene, etoxazole, azadirachtin, tebufenozide, | | | |
| indoxacarb, spinosad) | | | |
| Fungicide (for example, one or more of | 0% to 5% | 0% to 3% | 0% to 2% |
| azoxystrobin, tebuconozole, tetraconazole, | | | |
| thiophanate, triadimefon, myclobutanil, | | | |
| chlorothalonil, thiophanate-methyl, pyraclostrobin, | | | |
| triticonazole, triadimefon, trifloxystrobin) | | | |
| Other ingredients | 0% to 15% | 0% to 12% | 0% to 10% |

Table 2 lists components, corresponding total contert ranges (preferred, in percent weight of the total formulation), total mass percentage ratios (preferred), and certain additional characteristics for various non-limiting embodiments of concentrate formulations according to the present disclosure formulated for dilution into water at a rate of 1:2 to 1:100 concentrate to water. It will be understood that the components, contert ranges, ratios, and further particulars listed in Table 2 are exemplary and are not necessarily limiting of the invention of the present disclosure.

TABLE 2

| | | | Even |
|---|---|---|---|
| | | More | More |
| | Preferred | Preferred | Preferred |
| Concentrate formulation component | Range | Range | Range |
| Anionic surfactant (for example, one or more of | 0.1% to 60% | 0.1% to 30% | 0.5% to 20% |
| sodium dodecyl sulfate, ammonium dodecyl sulfate, | | | |
| sodium decyl sulfate, sodium octyl sulfate, sodium | | | |
| laureth sulfate, sodium myreth sulfate, sodium | | | |
| dodecylbenzenesulfonate, sodium bis(2- | | | |
| ethylhexyl)sulfosuccinate, sodium laurate, potassium | | | |
| laurate, ammonium laurate, sodium octanoate, | | | |
| sodium decanoate, sodium myristate, potassium | | | |
| decanoate, potassium stearate, and sodium 3,5,5- | | | |
| trimethylhexanoate) | | | |
| Acylglycerol-derived emulsifier (for example, one or | 0.1% to 50% | 0.1% to 30% | 0.5% to 20% |
| more of glycerol decanoate, diglyceryl monooleate, | | | |
| diglyceryl monostearate, dilaurin, dipalmitin, | | | |
| glycerol monolaurate, glycerol monooleate, glycerol | | | |
| dicaprylate, glycerol dimyristate, glycerol dioleate, | | | |
| glycerol distearate, glycerol monomyristate, glycerol | | | |
| monooleate, glycerol monostearate, glycerol | | | |
| stearate, 1-monolaurin, 1-monomyristin, | | | |
| monomyristin, monopalmitin, polyglycerol oleate, | | | |
| polyglycerol stearate, and tetraglycerol monooleate) | | | |
| Total mass percentage ratio of surfactant to | 50:1 to 1:100 | 25:1 to 1:20 | 10:1 to 1:10 |
| emulsifier | | | |
| Organic water-soluble solvent (for example, one or | 1% to 99% | 10% to 99% | 0.5% to 20% |
| more of propylene carbonate, ethylene carbonate, | | | |
| methanol, ethanol, 1-propanol, 2-propanol, t- | | | |
| butanol, 1-butanol, sec-butanol, iso-butanol, | | | |
| ethylene glycol, propylene glycol, diethylene glycol, | | | |
| (+)-butyl lactate, butyl lactate, (+)-ethyl lactate, | | | |
| ethyl lactate, glycerin, glyme, and acetone) | | | |
| Water | 0% to 60% | 0% to 50% | 0% to 40% |
| Total mass percentage ratio of microemulsion | 40:1 to 1:1.5 | 25:1 to 1:1 | 10:1 to 1:1 |
| system to water-insoluble component | | | |
| Fatty acid (for example, one or more of octanoic | 0% to 30% | 0% to 25% | 0% to 20% |
| acid, nonanoic acid, decanoic acid, lauric acid, | | | |
| myristic acid, palmitic acid, stearic acid, linoleic | | | |
| acid, oleic acid, 3,5,5-trimethylhexanoic acid, 7- | | | |
| methylnonanoic acid, and linolenic acid) | | | |
| pH modifier (for example, one or more of calcium | 0 to 3% | 0 to 2.5% | 0 to 2% |
| acetate, calcium acetate monohydrate, calcium | | | |
| carbonate, calcium citrate, citric acid, citric acid | | | |
| monohydrate, dipotassium citrate, disodium citrate, | | | |
| magnesium oxide, monopotassium citrate, | | | |
| monosodium citrate, potassium acetate, potassium | | | |
| bicarbonate, potassium citrate, sodium acetate, | | | |
| sodium bicarbonate, sodium citrate, tricalcium | | | |
| citrate, trisodium citrate, tripotassium citrate, | | | |
| tripotassium citrate monohydrate, trisodium citrate | | | |
| dihydrate, trisodium citrate pentahydrate, vinegar, | | | |
| acetic acid, citric acid, and malic acid) | | | |
| pH range | 2 to 12 | 2 to 10 | 2 to 9 |
| Preservative (for example, one or more of potassium | 0% to 3% | 0% to 2% | 0 to 1% |
| sorbate, sodium sorbate, ammonium benzoate, | | | |
| calcium benzoate, magnesium benzoate, potassium | | | |
| benzoate, sodium benzoate, benzoic acid, methyl | | | |
| paraben, ethyl paraben, DMDM hydantoin, 2- | | | |
| methyl-4-isothiazolin-3-one, benzalkonium chloride, | | | |
| EDTA, disodium EDTA) | | | |
| Antioxidant (for example, one or more of ascorbic | 0% to 3% | 0% to 2% | 0 to 1% |
| acid, tocopherols, vitamin E, BHT, BHA, EMQ, | | | |
| sodium ascorbate, potassium ascorbate, ascorbyl | | | |
| palmitate) | | | |
| Terpenes (for example, one or more of eugenol, | 0% to 20% | 0% to 17.5% | 0 to 15% |
| nootkatone, geraiol, nerol, 2-phenethyl propionate, | | | |
| citronellol, citral, citronellal, cinnamaldehyde, | | | |
| thymol, carvacrol, menthol, geranyl acetate, linalool, | | | |
| α-pinene, limonene, carveol, and carvone) | | | |
| Plant essential oil (for example, one or more of | 0% to 20% | 0% to 17.5% | 0 to 15% |
| cedarwood oil (China), cedarwood oil (Texas), | | | |
| cedarwood oil (Virginia), cinnamon oil, citronella | | | |
| oil, clove oil, cornmint oil, garlic oil, geranium oil, | | | |
| lemongrass oil, licorice extract, oregano oil, | | | |
| peppermint oil, rosemary oil, spearmint oil, thyme | | | |
| oil, wintergreen oil) | | | |
| Viscosity modifier/emulsifier (for example, one or | 0% to 2% | 0% to 1.5% | 0% to 1% |
| more of agar, acid-hydrolyzed amylopectin 1- | | | |
| octenylbutanedioate, amylopectin hydrogen 1- | | | |
| octenylbutanedioate, carboxymethyl cellulose, carob | | | |
| gum, carrageenan, cellulose acetate, sodium salt of | | | |
| cellulose carboxymethyl ether, cellulose, citrus | | | |
| pectin, gelatin, gellan gum, guar gum, gum Arabic, | | | |
| gum tragacanth, hydroxyethyl cellulose, | | | |
| hydroxypropyl cellulose, hydroxypropyl methyl | | | |
| cellulose, sodium alginate, sodium carboxymethyl | | | |
| cellulose, hydrogenated hydrolyzed starch syrups) | | | |
| Herbicide (for example, one or more of glyphosate, | 0% to 50% | 0% to 45% | 0% to 40% |
| glufosinate, 2,4-D, dicamba, MCPA, trichlopyr, | | | |
| fluroxypyr, halosulfuron-methyl, mesotrione, diquat, | | | |
| quinclorac, diuron, imazapyr, imazaquin, prometon, | | | |
| atrazine, dithiopyr, isoxaben, trifluralin, prodiamine, | | | |
| carfentrazone-ethyl, mecoprop-P, fluazifop-P-butyl, | | | |
| bispyribac, bromacil, chlorimuron-ethyl, clopyralid, | | | |
| cloransulam-methyl, sulfentrazone, simazine, | | | |
| norflurazon, quizalofop, topramezone) | | | |
| Insecticide (for example, one or more of abamectin, | 0% to 50% | 0% to 45% | 0% to 40% |
| bifenthrin, allethrin, cyfluthrin, λ-cyhalothrin, | | | |
| deltamethrin, DDVP, naled, fipronil, carbaryl, | | | |
| imidacloprid, chlorantraniliprole, hydroprene, | | | |
| methoprene, etoxazole, azadirachtin, tebufenozide, | | | |
| indoxacarb, spinosad) | | | |
| Fungicide (for example, one or more of | 0% to 50% | 0% to 45% | 0% to 40% |
| azoxystrobin, tebuconozole, tetraconazole, | | | |
| thiophanate, triadimefon, myclobutanil, | | | |
| chlorothalonil, thiophanate-methyl, pyraclostrobin, | | | |
| triticonazole, triadimefon, trifloxystrobin) | | | |
| Other ingredients | 0% to 15% | 0% to 12% | 0% to 10% |

In one non-limiting embodiment, the present invention provided an OWM herbicidal composition comprising, by weight, 9-15% sodium dodecyl sulfate as the surfactant, 1.5-5% glycerol monooctanoate as the acylglycerol-derived emulsifier, 8-20% propylene carbonate as the water-soluble organic cosolvent, a mixture of 1.5-7% lauric acid, 1-3% geraniol, 0-2.5% lemongrass oil, 0.0-1.0% triethyl citrate, and 0.0-1.0% isopropyl myristate as a water-immiscible active component, 0-1.5% acetic acid as a pH modifier, and 60-78% water. The formulation was an OWM herbicide that remained clear and nearly colorless for at least 10 days. The RTU formulation provided rapid plant burndown of grasses and broadleaf weeds.

In one non-limiting embodiment, the present invention provided an herbicidal composition comprising, by weight, 6-17% sodium dodecyl sulfate as the surfactant, 1.5-5% glycerol monooctanoate as the acylglycerol-derived emulsifier, 8-20% triethyl citrate as the water-soluble organic cosolvent, a mixture of 1.5-7% lauric acid, 1-3% rosemary oil, and 0.0-1.0% isopropyl myristate as a water-immiscible active component, 0-3% acetic acid as a pH modifier, and 60-85% water. The formulation was an OWM herbicide that remained clear and nearly colorless for at least 10 days. The RTU formulation provided rapid plant burndown of grasses and broadleaf weeds.

In one non-limiting embodiment, the present invention provided an herbicidal composition comprising, by weight, 6-12% sodium dodecyl sulfate and 0.25-3.0% sodium 3,5,5-trimethylhexanoate as the surfactant, 0.5-3% glycerol monooctanoate as the acylglycerol-derived emulsifier, 8-20% propylene carbonate and 0.5-3% isopropanol as the water-soluble organic cosolvent, a mixture of 1.5-6% lauric acid, 1-3% geraniol, 0-2.5% lemongrass oil, 0.0-1.0% triethyl citrate, and 0.0-1.0% isopropyl myristate as a water-immiscible active component, 0.05-1.0% ammonium benzoate as a preservative, and 64-80% water. The formulation was an OWM herbicide that remained clear and nearly colorless for at least 10 days. The RTU formulation provided rapid plant burndown of grasses and broadleaf weeds.

In one non-limiting embodiment, the present invention provided an herbicidal composition comprising, by weight, 10-15% sodium dodecyl sulfate as the surfactant, 2-5% glycerol monooctanoate and 0.5-1.5% of polyglycerol-4-oleate as the acylglycerol-derived emulsifier, 8-15% propylene carbonate and 1-3% isopropanol as the water-soluble organic cosolvent, a mixture of 2-6% lauric acid, 1-2% myristic acid, 1-3% geraniol, 0.0-2.0% lemongrass oil, 0.0-1.0% triethyl citrate, and 0.0-1.0% isopropyl myristate as a water-immiscible active component, 0.03% of a 35% aqueous citric acid solution as a pH modifier, and 60-75% water. The formulation was an OWM herbicide that remained clear and nearly colorless for at least 24 hours. The RTU formulation provided rapid plant burndown of grasses and broadleaf weeds.

In one non-limiting embodiment, the present invention provided an herbicidal composition comprising, by weight, 6-12% sodium dodecyl sulfate and 0.25-3.0% sodium 3,5,5-trimethylhexanoate as the surfactant, 0.5-3% glycerol monooctanoate and 0.1-1.2% of polyglycerol-4-oleate as the acylglycerol-derived emulsifier, 10-16% propylene carbonate as the water-soluble organic cosolvent, a mixture of 3-7% lauric acid, 1-2% geraniol, 0.0-1.0% lemongrass oil, 0.0-1.0% triethyl citrate, and 0.0-1.0% isopropyl myristate as a water-immiscible active component, 0.2% of a 35% aqueous citric acid solution as a pH modifier, and 60-78% water. The formulation was an OWM herbicide that remained clear and nearly colorless for at least 24 hours. The RTU formulation provided rapid plant burndown of grasses and broadleaf weeds.

In one non-limiting embodiment, the present invention provided an herbicidal composition comprising, by weight, 5-15% sodium dodecyl sulfate and 0.1-5.0% sodium 3,5,5-trimethylhexanoate as the surfactant, 0.1-5% glycerol monooctanoate and 0.1-2% of polyglycerol-4-oleate as the acylglycerol-derived emulsifier, 8-16% triethyl citrate as the water-soluble organic cosolvent, a mixture of 3-7% lauric acid, 1-5% rosemary oil, and 0.0-1.0% isopropyl myristate as a water-immiscible active component, 0.1-5% citric acid as a pH modifier, and 60-85% water. The formulation was an OWM herbicide that remained clear and nearly colorless for at least 24 hours. The RTU formulation provided rapid plant burndown of grasses and broadleaf weeds.

In one non-limiting embodiment, the present invention provides an herbicidal composition comprising, by weight, 6-10% sodium dodecyl sulfate and 0-3% sodium 3,5,5-trimethylhexanoate as the surfactant, 1-4% glycerol monooctanoate as the acylglycerol-derived emulsifier, 9-15% propylene carbonate and 0-4% isopropanol as the water-soluble organic cosolvent, a mixture of 2-6% lauric acid, 1-4% geraniol, and 0.0-1.5% lemongrass oil as a water-immiscible active component, 0.05-0.5% ammonium benzoate as a preservative, 0.0-0.5% palmityl ascorbate as an antioxidant, and 65-80% water. The RTU formulation provides rapid plant burndown of grasses and broadleaf weeds.

In one non-limiting embodiment, the present invention provides an herbicidal composition comprising, by weight, 13% sodium dodecyl sulfate as the surfactant, 2.5% glycerol monooctanoate as the acylglycerol-derived emulsifier, 12% propylene carbonate as the water-soluble organic cosolvent, a mixture of 4% lauric acid, 2% geraniol, 0.2% lemongrass oil, 1.0% glufosinate-ammonium as an herbicidal water-soluble active component, 0.2% ammonium benzoate as a preservative, 0.1% palmityl ascorbate as an antioxidant, and 64.6% water. The RTU formulation provides rapid plant burndown of grasses, broadleaf weeds, and woody plant suckers.

In one non-limiting embodiment, the present invention provides an herbicidal composition comprising, by weight, 10% sodium dodecyl sulfate and 0.8% sodium 3,5,5-trimethylhexanoate as the surfactant, 2.5% glycerol monooctanoate as the acylglycerol-derived emulsifier, 12.0% propylene carbonate as the water-soluble organic cosolvent, a mixture of 2.5% lauric acid, 0.5% decanoic acid, 2% geraniol, and 0.5% lemongrass oil as the water-immiscible active component, 0.2% ammonium benzoate as a preservative, 0.1% palmityl ascorbate as an antioxidant, 0.05% hydroxypropyl methyl cellulose as a viscosity modifier, 1.9% dimethylamine salt of 2,4-D and 0.85% dicamba as the herbicidal active component, and 66.1% water. The RTU formulation provides burndown and systemic broadleaf herbicidal activity.

In one non-limiting embodiment, the present invention provides an herbicidal composition comprising, by weight, 10% sodium dodecyl sulfate as the surfactant, 2.5% glycerol monodecanoate as the acylglycerol-derived emulsifier, 12.0% propylene carbonate as the water-soluble organic cosolvent, a mixture of 0.1% geraniol, and 0.2% lemongrass oil as the water-immiscible active component, 0.2% ammonium benzoate as a preservative, palmityl ascorbate as an antioxidant, 0.5% dimethylamine salt of 2,4-D, 0.3% dicamba, and 0.2% quinclorac as the herbicidal active component, and 73.9% water. The RTU formulation provides control of crabgrass and broadleaf weeds in lawns.

In one non-limiting embodiment, the present invention provides an herbicidal composition comprising, by weight, 9% sodium dodecyl sulfate as the surfactant, 3% glycerol monooctanoate as the acylglycerol-derived emulsifier, 12.0% propylene carbonate as the water-soluble organic cosolvent, a mixture of 0.1% 1,8-cineole and 0.2% eucalyptus oil as the water-immiscible active component, 0.2% ammonium benzoate as a preservative, palmityl ascorbate as an antioxidant, 0.6% fluazifop-P-butyl as the herbicidal active component, and 73.9% water. The RTU formulation provides control of grassy weeds in flower beds.

In one non-limiting embodiment, the present invention provides an herbicidal composition comprising, by weight, 8% sodium dodecylbenzene sulfonate as the surfactant, 1.0% polyglyceryl-4 dioleate and 1% polyglycerol-4 caprylate as the acylglycerol-derived emulsifier, 10% propylene carbonate and 1% tert-butanol as the water-soluble organic cosolvent, 1% cocoamide DEA as a non-acylglycerol-derived emulsifier, a mixture of 3% lauric acid, 2% geraniol, and 0.2% lemongrass oil as a water-immiscible active component, 2-methyl-4-isothiazolin-3-one as a preservative, 0.1% BHT as an antioxidant, and water. The RTU formulation provides rapid plant burndown of grasses and broadleaf weeds.

In one non-limiting embodiment, the present invention provided an insecticidal composition comprising, by weight, 1.5-4% sodium dodecyl sulfate as the surfactant, 1.5-5% polyglyceryl-10 oleate as the acylglycerol-derived emulsifier, 1-4% propylene carbonate, 0-3% butyl lactate, and 0-3% isopropanol as the water-soluble organic cosolvent, 0.1-1.0% geraniol, 0.1-2.0% rosemary oil, 0.0-1.0% triethyl citrate, and 0.0-1.0% isopropyl myristate as a water-immiscible active component, 0.05-0.5% hydroxypropyl methyl cellulose as a viscosity modifier, 0.05-.25% sodium benzoate as a preservative, and 78-90% water. The RTU formulation was clear and colorless for at least 7 days and provided insecticidal activity.

In one non-limiting embodiment, the present invention provided an insecticidal composition comprising, by weight, 2-4% sodium dodecyl sulfate as the surfactant, 1-3.5% polyglyceryl-10 oleate as the acylglycerol-derived emulsifier, 0.5-3.0% propylene carbonate, 0.0-1.0% butyl lactate, and 1.0-3.0% isopropanol as the water-soluble organic cosolvent, 0.1-1.5% geraniol, 0.1-1.5% cornmint oil, 0.0-1.0% triethyl citrate, and isopropyl myristate as a water-immiscible active component, 0.0-0.5% hydroxypropyl methyl cellulose as a viscosity modifier, 0.1% sodium benzoate as a preservative, and 83-91% water. The RTU formulation was clear and colorless for at least 7 days and provided insecticidal activity.

In one non-limiting embodiment, the present invention provides an insecticidal composition comprising, by weight, 6% sodium dodecyl sulfate as the surfactant, 4% polyglyceryl-4 laurate as the acylglycerol-derived emulsifier, 3% propylene carbonate, 1% butyl lactate, and 2% isopropanol as the water-soluble organic cosolvent, 2% geraniol and wintergreen oil as a water-immiscible active component, 0.1% hydroxyethyl cellulose as a viscosity modifier, 0.1% sodium benzoate as a preservative, and 82.55% water. The clear and colorless RTU formulation provides insecticidal activity.

In one non-limiting embodiment, the present invention provides an insecticidal composition comprising, by weight, 4-8% sodium dodecyl sulfate as the surfactant, 1-4% polyglyceryl-4 laurate as the acylglycerol-derived emulsifier, 2-5% propylene carbonate, butyl lactate, and 0-3% isopropanol as the water-soluble organic cosolvent, 0.5-2.0% geraniol and 0.2-1.0% lemongrass oil as a water-immiscible active component, 0.1% hydroxyethyl cellulose as a viscosity modifier, 0.1% sodium benzoate as a preservative, and 78-90% water. The clear and colorless RTU formulation provides insecticidal activity.

In one non-limiting embodiment, the present invention provides an insecticidal composition comprising, by weight, 4-8% sodium dodecyl sulfate as the surfactant, 1-4% polyglyceryl-4 laurate as the acylglycerol-derived emulsifier, 0.1-5% isopropanol as the water-soluble organic cosolvent, 0.1-4.0% geraniol and 0.1-3.0% rosemary oil as a water-immiscible active component, 0.1-2% hydroxyethyl cellulose as a viscosity modifier, 0.1-3% potassium sorbate as a preservative, and 70-90% water. The clear and colorless RTU formulation provides insecticidal activity.

In one non-limiting embodiment, the present invention provides an insecticidal composition comprising, by weight, 5% sodium dodecyl sulfate as the surfactant, 3% polyglyceryl-4 myristate as the acylglycerol-derived emulsifier, 5% propylene carbonate and 1% butyl lactate as the water-soluble organic cosolvent, 0.5% geraniol, 0.5% cornmint oil, and 0.1% bifenthrin as a water-immiscible insecticidal active component, 0.1% hydroxypropyl methyl cellulose as a viscosity modifier, 0.1% sodium benzoate as a preservative, and 84.7% water. The clear and colorless RTU formulation provides potert insecticidal activity.

In one non-limiting embodiment, the present invention provides an insecticidal composition comprising, by weight, 5% sodium dodecyl sulfate as the surfactant, 1% polyglyceryl-10 oleate and 1% monolaurin as the acylglycerol-derived emulsifier, 5% propylene carbonate and 1% ethyl lactate as the water-soluble organic cosolvent, 0.5% d-limonene, 0.2% orange oil, 0.15% prallethrin, and 0.2% ζ-cypermethrin as a water-immiscible insecticidal active component, 0.1% hydroxypropyl methyl cellulose as a viscosity modifier, 0.1% sodium benzoate as a preservative, and 85.75% water. The clear and colorless RTU formulation provides insecticidal activity against flying insects with rapid knockdown for stinging insects.

In one non-limiting embodiment, the present invention provides an insecticidal composition comprising, by weight, 2% sodium dodecyl sulfate as the surfactant, 1% glycerol monooctanoate as the acylglycerol-derived emulsifier, 2% propylene carbonate as the water-soluble organic cosolvent, 0.1% d-limonene, 0.1% orange oil, and 0.05% imidacloprid, and 0.05% bifenthrin as a water-immiscible insecticidal active component, hydroxypropyl methyl cellulose as a viscosity modifier, 0.1% ammonium benzoate as a preservative, and 94.5% water. The clear and colorless RTU formulation provides contact and systemic insecticidal activity for ornamental plants.

In one non-limiting embodiment, the present invention provides an insecticidal and fungicidal composition comprising, by weight, 2% sodium dodecyl sulfate as the surfactant, 1% glycerol monooctanoate as the acylglycerol-derived emulsifier, 2% propylene carbonate as the water-soluble organic cosolvent, 0.1% d-limonene, 0.1% orange oil, and imidacloprid, 0.05% bifenthrin, and 0.2% propiconazole as a water-immiscible insecticidal and fungicidal active component, 0.1% hydroxypropyl methyl cellulose as a viscosity modifier, 0.1% ammonium benzoate as a preservative, and 94.3% water. The clear and colorless RTU formulation provides contact and systemic insecticidal activity, as well as fungicidal activity, for ornamental plants.

In one non-limiting embodiment, the present invention provides a fungicidal composition comprising, by weight, 5-8% sodium dodecyl sulfate as the surfactant, 1.5-3% glycerol monolaurate as the acylglycerol-derived emulsifier, 4-7% propylene carbonate as the water-soluble organic cosolvent, 0.2-1.0% thyme oil, 0.2-1.0% cinnamon oil, and 0.1-wintergreen oil as a water-immiscible active component, 0.1-0.5% sodium sorbate as a preservative, 0.1% tocopherols as an antioxidant, and 80-88% water. The clear and colorless RTU formulation provides fungicidal activity for ornamental and crop plants.

In one non-limiting embodiment, the present invention provides a fungicidal composition comprising, by weight, 5% sodium dodecyl sulfate as the surfactant, 2% glycerol monolaurate as the acylglycerol-derived emulsifier, 5% propylene carbonate as the water-soluble organic cosolvent, 0.3% thyme oil, 0.2% thymol, and 0.1% azoxystrobin as a water-immiscible fungicidal active component, 0.1% potassium sorbate as a preservative, and 87.3% water. The clear and colorless RTU formulation provides fungicidal activity for ornamental plants.

In one non-limiting embodiment, the present invention provides a fungicidal composition comprising, by weight, 7.5% sodium dodecyl sulfate as the surfactant, 2% polyglycerol-4 monooleate and 1% monolaurin as the acylglycerol-derived emulsifier, 5% propylene carbonate and 1% 1-butanol as the water-soluble organic cosolvent, 0.2% myclobutanil, 0.05% azoxystrobin, 0.25% thiophanate-methyl, and 0.5% cinnamon oil as a water-immiscible fungicidal active component, 0.1% potassium sorbate as a preservative, and 87.3% water. The clear and colorless RTU formulation provides fungicidal activity with multiple modes of action for ornamental plants and lawns.

In some embodiments, the microemulsion system serves to stabilize microparticles as a milky emulsion. The components of the microemulsion system aid in controlling the dispersity of the microparticles and slow separation of the emulsion. In certain non-limiting embodiments of methods according to the present disclosure, a clear, colorless microemulsion system according to the present disclosure is first assembled in water, and a water-insoluble component comprising an active component is then added under high shear to form a stabilized, milky emulsion. Emulsions produced by using a drying or hardening component are desirable as they leave minimal greasy residue upon drying.

As used herein, “hardening component” refers a compound that is solid at 25° C. and has solubility in water below 1%. Suitable hardening components include, for example, carnauba wax, beeswax, C14-C22 fatty acids, C14-C40 fatty alcohols, shellac, paraffin wax, candelilla wax, microcrystalline wax, rice bran wax, bayberry wax, castor wax, sugarcane wax, plant waxes, esters formed by the esterification of a fatty acid with a fatty alcohol, and the like. The inclusion of a hardening component permits the microencapsulation of other active components, including plant essential oils, fats, pesticides, and the like, in solid microparticles, which are known to allow controlled release of volatiles or pesticidal compounds.

In one non-limiting embodiment, the present invention provided an insect repellent composition comprising, by weight, 0.5% sodium dodecyl sulfate and 0.5% sodium tallowate as the surfactant, 0.5% glycerol monostearate as the acylglycerol-derived emulsifier, 2% isopropanol and 0.1% glycerol as the water-soluble organic cosolvent, and 2.7% geraniol, 2.1% vanillin, 0.1% isopropyl myristate, 0.1% triethyl citrate, and 5.0% refined carnauba wax as the active component, and 87.2% water. The sodium dodecyl sulfate, sodium tallowate, glycerol monostearate, isopropanol, and glycerol were mixed and heated to 95° C. The active component ingredients were separately heated to 95° C. and mixed to form a homogeneous oil, which was then added to the microemulsion-water mixture under high shear (homogenization), followed by cooling to 20° C. The formulation provides a dispersion of waxy microparticles suspended in a microemulsion. Application of the emulsion to a surface provided insect-repellent properties for at least five weeks without the presence of a greasy residue.

In one non-limiting embodiment, the present invention provided an insect repellent composition comprising, by weight, 0.5% sodium dodecyl sulfate and 0.5% sodium tallowate as the surfactant, 0.5% glycerol monostearate as the acylglycerol-derived emulsifier, 2% isopropanol and 0.1% glycerol as the water-soluble organic cosolvent, and 2.0% geraniol, 2.0% vanillin, 0.1% isopropyl myristate, 0.1% triethyl citrate, and 5.0% refined carnauba wax as the active component, 0.5% hydroxypropyl methyl cellulose as a viscosity modifier, and 87.7% water. The sodium dodecyl sulfate, sodium tallowate, glycerol monostearate, isopropanol, hydroxypropyl methyl cellulose, and glycerol were mixed and heated to 95° C. The active component ingredients were separately heated to 95° C. and mixed to form a homogeneous oil, which was then added to the microemulsion-water mixture under high shear (homogenization), followed by cooling to 20° C. The formulation provides a dispersion of waxy microparticles suspended in a microemulsion. Application of the emulsion to a surface provided insect-repellent properties for at least five weeks without the presence of a greasy residue.

In one non-limiting embodiment, the present invention provides an insect repellent composition comprising, by weight, 0.5% sodium dodecyl sulfate and 0.5% sodium laurate as the surfactant, 0.5% glycerol monolaurate as the acylglycerol-derived emulsifier, 2% isopropanol and 0.1% propylene carbonate as the water-soluble organic cosolvent, and 2.0% geraniol, 1.5% vanillin, 0.5% lemongrass oil, 0.2% bifenthrin, and 4.0% refined carnauba wax as the active component, 0.2% ceteareth-25 as a viscosity modifier, and 89.8% water. The sodium dodecyl sulfate, sodium laurate, glycerol monolaurate, isopropanol, hydroxypropyl methyl cellulose, and glycerol were mixed and heated to 95° C. The active component ingredients were separately heated to 95° C. and mixed to form a homogeneous oil, which was then added to the microemulsion-water mixture under high shear (homogenization), followed by cooling to 20° C. The formulation provides a dispersion of waxy microparticles suspended in a microemulsion. Application of the emulsion to a surface provides insect-repellent and insecticidal properties for at least five weeks without the presence of a greasy residue.

Various non-limiting aspects according to the present disclosure are provided in the following clauses. It will be understood that the inventions described in the following clauses are exemplary only, and are not necessarily limiting of the invention of the present disclosure.

Clause 1: A composition comprising:
a. an anionic surfactant selected from the group consisting of: sulfates, sulfonates, ethoxylated sulfates, sulfosuccinates, metal salts of fatty acids, ammonium salts of fatty acids, or combination of two or more thereof;
b. an acyglycerol-derived emulsifier selected from the group consisting of: monoacylglycerols, diacylglycerols, polyglycerol fatty acid monoesters, polyglycerol fatty acid multi-esters or combination of two or more thereof;
c. a water-soluble organic cosolvent selected from the group consisting: of alcohols, organic carbonate esters, aliphatic glycols, glycol monoethers, glycol diethers, carboxylate esters, dialkyl sulfoxides, N,N-dialkylamides, carboxylic acids, acetone, 2-butanone, or combination of two or more
   thereof,
   wherein the components (a), (b), and (c) are dispersed in water to form an emulsion.

Clause 2: The composition of clause 1, wherein the composition further comprises a water-immiscible phase.

Clause 3: The composition of any of clauses 1 and 2, comprising, in weight percentages based on weight of the composition:
about 0.1% to about 30% of the surfactant;
about 0.1% to about 30% of the acylglycerol-derived emulsifier;
about 0.1% to about 60% of the water-soluble organic cosolvent;
about 0.1% to about 50% of a water-immiscible phase; and
about 0.1% to about 99.6% water.

Clause 4: The composition of any of clauses 1-3, wherein the composition is a microemulsion.

Clause 5: The composition of any of clauses 1-3, wherein the composition is a micellar dispersion.

Clause 6: The composition of any of clauses 1-5, wherein a ratio of the total mass percentage of the water-immiscible phase to the sum of the total mass percentages of the surfactant, the acylglycerol-derived emulsifier, and the water soluble cosolvent is about 1:100 to 1:1.

Clause 7: The composition of any of clauses 1-6, wherein the viscosity of the composition is in the range of about 5 cP to about 100 cP.

Clause 8: The composition of any of clauses 1-7, wherein the water-immiscible phase is selected from the group consisting of terpenes, plant essential oils, vegetable oils, paraffin oils, waxes, fatty acids, fatty alcohols, triglycerides, animal fats, vegetable oils, linear, branched, or cyclic hydrocarbons with 5 or more carbon atoms, aromatic hydrocarbons, halogenated hydrocarbons, amines, linear or cyclic silicones, and a combination of two or more thereof.

Clause 9: The composition of any of clauses 1-8, wherein the composition further comprises one or more additive selected from the group consisting of pH modifiers, preservatives, antioxidants, viscosity modifiers, non-acylglycerol-derived emulsifiers, and a combination of two or more thereof.

Clause 10: The composition of any of clauses 1-9, wherein the composition includes a pH modifier selected from the group consisting of inorganic acids, carboxylic acids, inorganic bases, organic bases, inorganic buffers, organic buffers, nd a combination of two or more thereof.

Clause 11: The composition of any of clauses 1-10, wherein the composition includes a pH modifier that bring the pH of the composition to a range of about 2 to about 12.

Clause 12: The composition of any of clauses 1-10 wherein the composition includes a pH modifier that brings the pH of the composition to a range that inhibits microbial growth.

Clause 13: The composition of any of clauses 1-12, wherein the composition includes a pH modifier selected from the group consisting of calcium acetate, calcium acetate monohydrate, calcium carbonate, calcium citrate, citric acid, citric acid monohydrate, dipotassium citrate, disodium citrate, magnesium oxide, monopotassium citrate, monosodium citrate, potassium acetate, potassium bicarbonate, potassium citrate, sodium acetate, sodium bicarbonate, sodium citrate, tricalcium citrate, trisodium citrate, tripotassium citrate, tripotassium citrate monohydrate, trisodium citrate dihydrate, trisodium citrate pentahydrate, vinegar, acetic acid, citric acid, malic acid, and a combination of two or more thereof.

Clause 14: The composition of any of clauses 1-13, wherein the composition includes a preservative selected from the group consisting of sorbates, benzoates, sulfites, nitrites, nitrates, parabens, EDTA, EDTA salts, formates, acetates, guanidinium salts, quaternary ammonium salts, ureas, isothiazolinones, benzisothiazolinones, ureas, terpenes, plant essential oils, and a combination of two or more thereof.

Clause 15: The composition of any of clauses 1-14, wherein the composition includes a preservative selected from the group consisting of potassium sorbate, ammonium benzoate, calcium benzoate, magnesium benzoate, potassium benzoate, sodium benzoate, and a combination of two or more thereof.

Clause 16: The composition of any of clauses 1-15, wherein the composition includes an antioxidant selected from the group consisting of ascorbates, tocopherols, phenols, hydroquinones, quinolines, and a combination of two or more thereof.

Clause 17: The composition of any of clauses 1-16, wherein the composition includes an antioxidant selected from the group consisting of ascorbyl palmitate, ascorbic acid, vitamin C, vitamin E, and a combination of two or more thereof.

Clause 18: The composition of any of clauses 1-17, wherein the composition includes a viscosity modifier selected from the group consisting of cellulose derivatives, plant gums, polysaccharides, sorbitan esters, polyglycols, polyglycerols, acylglycerols, polyethylene glycol ethers, proteins, and a combination of two or more thereof.

Clause 19: The composition of any of clauses 1-18, wherein the composition includes a viscosity modifier selected from the group consisting of agar, acid-hydrolyzed amylopectin 1-octenylbutanedioate, amylopectin hydrogen 1-octenylbutanedioate, carboxymethyl cellulose, carob gum, carrageenan, cellulose acetate, sodium salt of cellulose carboxymethyl ether, cellulose, citrus pectin, gelatin, gellan gum, guar gum, gum Arabic, gum tragacanth, hydroxyethyl cellulose, hydroxypropyl cellulose, hydroxypropyl methyl cellulose, sodium alginate, sodium carboxymethyl cellulose, hydrogenated hydrolyzed starch syrups, and a combination of two or more thereof.

Clause 20: The composition of any of clauses 1-19, wherein the composition includes a viscosity modifier to bring the viscosity to the range of about 5 cP to about 250 cP.

Clause 21: The composition of any of clauses 1-20, wherein the composition includes a non-acylglycerol-derived emulsifier selected from the group consisting of cellulose derivatives, plant gums, polysaccharides, sorbitan esters, polyglycols, polyglycerols, triacylglycerols, polyethylene glycol ethers, fatty alcohols, ethoxylated fatty alcohols, fatty acids, lecithins, fatty acid amides, and a combination of two or more thereof.

Clause 22: The composition of any of clauses 1-21, wherein the composition includes a water-immiscible phase comprising a terpene and a plant essential oil.

Clause 23: The composition of any of clauses 1-22, wherein the composition includes a terpene and a plant essential oil that result in synergistic pesticidal activity.

Clause 24: The composition of any of clauses 1-23, wherein the composition includes a water-immiscible phase comprising a fatty acid.

Clause 25: The composition of any of clauses 1-24, wherein the composition includes a combination of fatty acid, plant essential oil, and terpene that results in synergistic pesticidal activity.

Clause 26: The composition of any of clauses 1-25, wherein the composition comprises one or more synthetic pesticide.

Clause 27: The composition of any of clause 1-26, wherein the composition comprises a synthetic pesticide selected from the group consisting of herbicides, fungicides, insecticides, insect repellents, antibacterials, antivirals, nematicides, algicides, molluscicides, and combinations thereof.

Clause 28: The composition of any of clauses 25-26, wherein the composition comprises a plant essential oil, a terpene, or a combination thereof.

Clause 29: The composition of clause 28 wherein the plant essential oil, terpene, or combination thereof acts synergistically with one or more pesticide in the composition.

Clause 30: The composition of any of clauses 1-29, wherein the anionic surfactant is selected from the group consisting of sodium alkyl sulfates, sodium salts of fatty acids, potassium salts of fatty acids, ammonium salts of fatty acids, calcium salts of fatty acids, magnesium salts of fatty acids, and combinations of two or more thereof.

Clause 31: The composition of any of clauses 1-30, wherein the anionic surfactant is selected from the group consisting of sodium dodecyl sulfate, ammonium stearate, calcium octanoate, calcium stearate, potassium octanoate, sodium octanoate, magnesium stearate, potassium myristate, potassium oleate, potassium ricinoleate, potassium stearate, sodium oleate, sodium ricinolate, sodium stearate, and combinations of two or more thereof.

Clause 32: The composition of any of clauses 1-31, wherein the acylglycerol-derived emulsifier is selected from the group consisting of glycerol decanoate, diglyceryl monooleate, diglyceryl monostearate, dilaurin, dipalmitin, glycerol monolaurate, glycerol monooleate, glycerol dicaprylate, glycerol dimyristate, glycerol dioleate, glycerol distearate, glycerol monomyristate, glycerol monooleate, glycerol monostearate, glycerol stearate, 1-monolaurin, 1-monomyristin, monomyristin, monopalmitin, polyglycerol oleate, polyglycerol stearate, tetraglycerol monooleate, and combinations of two or more thereof.

Clause 33: The composition of any of clauses 1-32, wherein the water-soluble organic solvent is selected from the group consisting of (+)-butyl lactate, butyl lactate, (+)-ethyl lactate, ethyl lactate, glycerin, isopropanol, triethyl citrate, propylene carbonate, and combinations of two or more thereof.

Clause 34: The composition of any of clauses 1-33, wherein the composition comprises a plant essential oil selected from the group consisting of cedarwood oil (China), cedarwood (Texas), cedarwood (Virginia), cinnamon oil, citronella oil, clove oil, cornmint oil, garlic oil, geranium oil, lemongrass oil, licorice extract, peppermint oil, rosemary oil, spearmint oil, thyme oil, almond oil, wintergreen oil, and combinations of two or more thereof.

Clause 35: The composition of any of clauses 1-33, wherein the composition comprises aterpene selected from the group consisting of eugenol, geraniol, nootkatone, 2-phenethyl propionate, and combinations of two or more thereof.

Clause 36: The composition of any of clauses 1-35, wherein the composition is an emulsion.

Clause 37: The composition of any of clauses 1-36, wherein a ration of a total mass percentage of the water-immiscible phase to the sum of total mass percentages of the anionic surfactant, the acylglycerol-derived emulsifier, and the water soluble cosolvent is about 1:5 to about 10:1.

Clause 38: The composition of any of clauses 1-37, wherein the water-immiscible phase comprises (a) a hardening component and (b) a water-immiscible component selected from the group consisting of plant essential oils, vegetable oils, animal fats, terpenes, pesticides, and a combination of two or more thereof.

1. A composition comprising:
(a) an anionic surfactant selected from the group consisting of sulfates, sulfonates, ethoxylated sulfates, sulfosuccinates, metal salts of fatty acids, ammonium salts of fatty acids, and combinations of two or more thereof;
(b) an acylglycerol-derived emulsifier selected from the group consisting of monoacylglycerols, diacylglycerols, polyglycerol fatty acid monoesters, polyglycerol fatty acid multi-esters, and combinations of two or more thereof; and
(c) a water-soluble organic cosolvent selected from the group consisting of alcohols, organic carbonate esters, aliphatic glycols, glycol monoethers, glycol diethers, carboxylate esters, dialkyl sulfoxides, NA-dialkylamides, carboxylic acids, acetone, 2-butanone, and combinations of two or more thereof;
wherein the components (a), (b), and (c) disperse in water to form an emulsion.

2. The composition of claim 1, wherein the composition further comprises a water-immiscible phase.

3. The composition of claim 2 comprising:
about 0.1% to about 30% of the anionic surfactant;
about 0.1% to about 30% of the acylglycerol-derived emulsifier;
about 0.1% to about 60% of the water-soluble organic cosolvent;
about 0.1% to about 50% of the water-immiscible phase; and
about 0.1% and about 99.6% water.

4. The composition of claim 3, wherein the composition is a microemulsion.

5. The composition of claim 3, wherein the composition is a micellar dispersion.

6. The composition of claim 3, wherein a ratio of a total mass percentage of the water-immiscible phase to a sum of total mass percentages of the anionic surfactant, the acylglycerol-derived emulsifier, and the water soluble cosolvent is about 1:100 to about 1:1.

7. The composition of claim 3, wherein the viscosity of the composition is in the range of about 5 cP to about 100 cP.

8. The composition of claim 3, wherein the water-immiscible phase comprises a compound selected from the group consisting of terpenes, plant essential oils, vegetable oils, paraffin oils, waxes, fatty acids, fatty alcohols, triglycerides, animal fats, vegetable oils, linear, branched, or cyclic hydrocarbons with 5 or more carbon atoms, aromatic hydrocarbons, halogenated hydrocarbons, amines, linear or cyclic silicones, and combinations of two or more thereof.

9. The composition of claim 3, wherein the composition further comprises one or more additives selected from the group consisting of pH modifiers, preservatives, antioxidant, viscosity modifiers, non-acylglycerol-derived emulsifiers, and combinations of two or more thereof.

10. The composition of claim 3, wherein the composition further comprises a pH modifier selected from the group consisting of inorganic acids, carboxylic acids, inorganic bases, organic bases, inorganic buffers, organic buffers, and combinations of two or more thereof.

11. The composition of claim 10, wherein the pH modifier adjusts a pH of the composition to a range of about 2 to about 12.

12-13. (canceled)

14. The composition of claim 3, wherein the composition comprises a preservative selected from the group consisting of sorbates, benzoates, sulfites, nitrites, nitrates, parabens, EDTA, EDTA salts, formates, acetates, guanidinium salts, quaternary ammonium salts, ureas, isothiazolinones, benzisothiazolinones, ureas, terpenes, plant essential oils, and combinations of two or more thereof.

15. (canceled)

16. The composition of claim 3, wherein the composition comprises an antioxidant selected from the group consisting of ascorbates, tocopherols, phenols, hydroquinones, quinolines, and combinations of two or more thereof.

17. (canceled)

18. The composition of claim 3, wherein the composition comprises a viscosity modifier selected from the group consisting of: cellulose derivatives, plant gums, polysaccharides, sorbitan esters, polyglycols, polyglycerols, acylglycerols, polyethylene glycol ethers, proteins, and combinations of two or more thereof.

19-20. (canceled)

21. The composition of claim 3, wherein the composition comprises a non-acylglycerol-derived emulsifier selected from the group consisting of cellulose derivatives, plant gums, polysaccharides, sorbitan esters, polyglycols, polyglycerols, triacylglycerols, polyethylene glycol ethers, fatty alcohols, ethoxylated fatty alcohols, fatty acids, lecithins, fatty acid amides, and combinations of two or more thereof.

22. The composition of claim 8, wherein the water-immiscible phase comprises a terpene and a plant essential oil.

23. (canceled)

24. The composition of claim 22, wherein the water-immiscible phase further comprises a fatty acid.

25. (canceled)

26. The composition of claim 3, wherein the composition further comprises one or more synthetic pesticide.

27. (canceled)

28. The composition of claim 26, wherein the composition further comprises a plant essential oil, a terpene, or a combination thereof.

29-35. (canceled)

36. The composition of claim 3, wherein the composition is an emulsion.

37-38. (canceled)
